(19) United States
(12) Patent Application Publication
(10) Pub. No.: US 2002/0091793 A1
(43) Pub. Date: Jul. 11, 2002

(54) Method and system for tourist guiding, including both navigation and narration, utilizing mobile computing and communication devices

(76) Inventor: Isaac Sagie, Haifa (IL)

Correspondence Address: DR. MARK FRIEDMAN LTD., C/o Bill Polkinghorn, Discovery Dispatch, 9003 Florin Way, Upper Marlboro, MD, 20772, US

(21) Appl. No.: 09/982,848

(22) Filed: Oct. 22, 2001

Related U.S. Application Data
(60) Provisional application No. 60/242,173, filed on Oct. 23, 2000.

(51) Int. Cl. G06F 7/00

(52) U.S. Cl. 709/217; 707/10

(57) ABSTRACT

A method and system for tourist guiding, including both navigation and narration, utilizing mobile computing devices such as electronic books, palm computers, smart cellular phones, and future wearable computers is described. Loaded with, or Internet-connected to a Digital Guidebook, the system navigates the tourist to and within tour sites using an invented Visual Navigation method, and provides detailed multimedia narrations on objects along the tour. The system also navigates the tourist to other tourist destinations such as hotels and restaurants. An additional preferred embodiment combines GPS and CPS navigation with Visual Navigation. The system also creates a Digital Tour Album that captures the time and the places where the tourist has visited. The system also allows Armchair Touring and provides Tour Reviews on DVD. The Electronic Tourist Guide is based on latest mobile and wireless communication technologies and allows Internet channeling of live, timely information such as special events, latest prices and schedules. Digital Guidebooks can be downloaded to the tourist's device memory, or streamed to the tourist's device in real-time during the tour. The present invention entails two technologies: studio production and distribution of multimedia Digital Guidebooks, and use of mobile digital tourist guidebooks. The latter field entails mobile computing devices, wireless broadband Internet, and Geographic Information Systems.

### FIELD AND BACKGROUND OF THE INVENTION

### BACKGROUND OF THE INVENTION

### FIELD OF THE INVENTION

1. Technical Field

The present invention relates to two technical fields: production and publication of multimedia tourist guidebooks, and applications for mobile and wireless computing devices.

2. Description of the Related Art

Tourist guidebooks have not changed significantly in decades. Millions of tourists roam the world with printed guidebooks, spending long and frustrating time to match what they read to what they see and vice versa. Some tour sites rent out audio guides but those have limited use and require special logistics. A private tour guide provides a better form of guidance but is much more expensive and not as ubiquitous as printed guidebooks.

During the coming decade, mobile computing, wireless broadband Internet, and mobile navigation systems will completely change the way we carry out routine activities. This invention harnesses these technologies to revolutionize the way we use tour guidance.

Today we are familiar with two types of mobile computing devices: smart phones and palm computers. Not surprisingly, the two increasingly overlap in form and function. An emerging mobile device is the electronic book that provides a reading experience similar to that of paper books. Later developments should see the emersion of wearable computers that may enable virtual reality and enhanced reality experiences.

Wireless broadband Internet allows real-time transmission of audio-video information and fast downloads and synchronization of information from favorite web sites. It is not difficult to predict that mobile computing devices will soon be equipped for wireless broadband Internet access.

Mobile navigation systems based on GPS (Global Positioning System) are available on the market for quite some time but still not widely used. Mobile navigation based on CPS (Cellular Position Systems) will also appear soon. Both navigation systems, when available, will be useful for arriving at the tour site but useless within them. Complementing GPS and CPS navigation with the invented Visual Navigation and taking over when GPS and CPS are not available will provide a complete navigation system for pedestrian tourists.

Even publishing traditional guidebooks in a digital edition for mobile devices is in and of itself is a leap forward in the tourist guides industry. But the Electronic Tourist Guide offers much more.

Multimedia narration: most people prefer a human guide to a printed guidebook because listening and watching is easier and more fun than reading. The invented system takes advantage of multimedia capabilities of today's and future mobile devices to provide the best presentation method possible.

Live information: guidebooks never contain all the information about tour sites. Moreover this information is never up to date. Latest price and schedule information, for example, can only be found at the tour site itself. Wireless broadband Internet allows direct and live channeling of additional timely information from the site right into the tourist's mobile device.

Navigation: tourists need to navigate to the tour site and within it as well as to other tourist destinations such as hotels, restaurants, shops and theaters. Most guidebooks provide maps and other navigation aids but they all suffer from the inherent passive nature of printed material. The addition of the invented tourist navigation capability leaps frog Digital Guidebooks well beyond the state of the art.

There is thus a widely recognized need for, and it would be highly advantageous to have, a system that can enable electronic tourist guidance, including navigation and narration. Such a system should provide a high level of multimedia interactivity and should be usable from a variety of fixed and mobile computing and communication devices.

### SUMMARY OF THE INVENTION

The present invention provides a computer system and methods for electronic tourist guidance, including navigation and narration.

A method and system for tourist guiding, including both navigation and narration, utilizing mobile computing devices such as electronic books, palm computers, smart cellular phones, and future wearable computers is described. Loaded with, or Internet-connected to a Digital Guidebook, the system navigates the tourist to and within tour sites using an invented Visual Navigation method, and provides detailed multimedia narrations on objects along the tour. The system also navigates the tourist to other tourist destinations such as hotels and restaurants. An additional preferred embodiment combines GPS and CPS navigation with Visual Navigation. The system also creates a Digital Tour Album that captures the time and the places where the tourist has visited. The system also allows Armchair Touring and provides Tour Reviews on DVD. The Electronic Tourist Guide is based on latest mobile and wireless communication technologies and allows Internet channeling of live, timely information such as special events, latest prices and schedules. Digital Guidebooks can be downloaded to the tourist's device memory, or streamed to the tourist's device in real-time during the tour.

The present invention entails two technologies: studio production and distribution of multimedia Digital Guidebooks, and use of mobile digital tourist guidebooks. The latter field entails three technologies: (1) mobile computing devices, (2) wireless broadband Internet, and (3) Geographic Information Systems.

A method and system is described for studio production and distribution of Digital Guidebooks for Electronic Tourist Guides. The system allows authors to design and produce Digital Guidebooks with multi-media content and to package such Digital Guidebooks for use by tourists. The studio method is suited for professional writers and publishers of tourist guidebooks.

A method and system for mapping of tourist sites is also described. The system allows cartographers at operators of tourist sites to create Digital Navigation Maps of the site for reference in Digital Guidebooks.

A method and system for storing and selling Digital Guidebooks is described. The system allows Mobile Service Providers—an emerging Internet business model, to service tourist and bill for this service.

The medium of navigation and narration is adaptive to the features supported by the mobile device—from text only, text enhanced by visuals to audio only, audio-visual, audio-video and, in future extensions, Enhanced Reality. An important aspect of the invented system is its adaptive architecture that can grow to utilize new mobile technologies. The depth and orientation of the narration is adaptive to the tourist preference and allows general narrations as well as highly orientated narrations.

The computer system is made of five interacting subsystems: a Mobile subsystem, a Home subsystem, an Author subsystem, a Cartographer subsystem, and a Service subsystem.

Mobile and Home Subsystem

The mobile subsystem caters for the guidance needs of the tourist—both navigation and narration. The mobile subsystem might locally reside in the mobile device or be remotely accessed by wireless Internet communication to the Service (through a Mobile Service Provider). The mobile subsystem provides the following main features:

1. Multimedia narrations at tour sites, adjusted in form and content to the features of the mobile device and to the tourist's preference

2. Navigation at the tour site

3. Navigation to the tour site and to other tourist destinations such as hotels. restaurants, and theaters

4. Internet channels to live, timely information at tour sites and other tourist destinations

5. Viewing of Tour Albums

6. Small-Screen Armchair Touring

7. Administrative features such as login, purchase of Digital Guidebooks, downloads, connect/disconnect, and preference setting.

The behavior of the mobile subsystem varies depending on the features supported by the mobile device and the tourist's preferences. Examples: devices that support wireless Internet will also connect to Internet channels for live information: otherwise only permanent content will be shown. Devices that support audio streaming will allow voice narration; otherwise only visual narrations will be provided. Devices that support wireless broadband Internet will allow real-time streaming of Digital Guidebooks; otherwise, only in-memory downloaded guidebooks will be allowed. Similarly, the tourist can ask for general narration of for specific orientation such as Art, History, and alike.

The home subsystem complements the mobile subsystem with more stationary tourist functions:

1. Fast download of Digital Guidebooks from the Service subsystem

2. Creation of Digital Tour Albums

3. Large screen viewing of the Tour Album

4. Large screen Armchair Touring

Author Subsystem

The Author Subsystem is a production studio for Digital Guidebooks. It provides tools for professional guidebook writers and publishers to design and produce Digital Guidebooks for use by the Mobile subsystem. The Author Subsystem offers the following features:

1. Tour programming: definition of sites, tours, stations, objects, and other tourist destinations; definition of narration topics—general and specialized.

2. Integration of multimedia tour material

3. Integration of Digital Navigation Maps from the Cartographer subsystem

4. Integration of Internet channels

5. Compilation of Digital Guidebooks

6. Reduction of Digital Guidebooks to fit different mobile devices

Cartographer Subsystem

To provide Visual Navigation, the Digital Guidebook needs access to a Digital Navigation Map. The Cartographer Subsystems allows the mapping of tour sites and other tourist destinations nd the creation of Digital Navigation Maps. The Cartographer Subsystem provides the following main features:

1. Import of existing digital maps

2. Creation of new digital maps

3. Addition of tour destinations to the maps, sharing a Destination Directory with the Author Subsystem to create Digital Navigation Maps.

Service Subsystem

The Service Subsystem allows the electronic storage, sale, and service of Digital Guidebooks by Mobile Service Providers. In addition to common e-commerce functions, the Service Subsystem supports the following specific transactions:

1. Customer Registration

2. Tourist Login and Logout

3. Purchase of Guidebooks

4. Purchase of Online Guiding

5. Start/Pause/Resume/End Online Guiding

6. Purchase of DVD Tour Reviews

7. Creation of and delivery of Tour Albums

Customer billing for products and services

### BRIEF DESCRIPTION OF THE DRAWINGS

The invention is herein described, by way of example only, with reference to the accompanying drawings, wherein:

FIG. 1 illustrates the three types of mobile devices for which the system is presently designed: Electronic Books, Palm Computers, and Smart Cellular Telephones.

FIG. 2 describes the five subsystems, which comprise the entire system and the three side-products—Digital Guidebooks, Digital Navigation Maps, and Digital Tour Albums.

FIG. 3 describes the general flow of the Mobile subsystem. Detailed flow charts follows.

FIG. 4 outlines the main concepts and terms of the Electronic Tourist Guiding system.

FIG. 5 describes the Navigation/Narration flow at a tour site.

FIG. 6 describes the process of selecting a site among multiple sites or a tour among multiple tours.

FIG. 7 describes the process of guiding tours within a site

FIG. 8 describes the process of guiding stations within a tour

FIG. 9 describes the process of guiding objects with a station

FIG. 10 describes the process of narrations of a guidebook, a site, a tour, a station, and an object.

FIG. 11 describes the process of selecting narration topics from a list of topics.

FIG. 12 describes the process of presenting multimedia content

FIG. 13 describes the process of Visual Navigation

FIG. 14 illustrates a Digital Navigation Map

FIG. 15 illustrates target identification

FIG. 16 illustrates a navigation locator—street junction, place, or establishment.

FIG. 17 describes the process of navigation to other tourist destinations

FIG. 18 describes the general flow of the Home subsystem.

FIG. 19 describes in details the three functions of the home subsystem: fast download, Armchair Touring, and creation of Tour Albums.

FIG. 20 describes the Author subsystem, also called the Studio

FIG. 21 outlines the structure of a Guidebook Script

FIG. 22 outlines the structure of the Introduction Chapter of the Guidebook Script

FIG. 23 outlines the structure of the Guide Chapters of the Guidebook Script

FIG. 24 outlines the structure of the Destinations Chapter of the Guidebook Script

FIG. 25 describes the Destination Directory, shared by the Author Subsystem and the Cartographer Subsystem.

FIG. 26 lists the supported media for navigation and narration

FIG. 27 and FIG. 28 define the guidebook script in XML Document Type Definition

FIG. 29 describes the Cartographer Subsystem flow

FIG. 30 describes the Server Subsystem transactions flow

### DESCRIPTION OF THE PREFERRED EMBODIMENT

The present invention relates to a system and method for tourist guiding, including both navigation and narration, utilizing mobile computing devices such as electronic books, palm computers, smart cellular phones, and future wearable computers is described.

The following description is presented to enable one of ordinary skill in the art to make and use the invention as provided in the context of a particular application and its requirements. Various modifications to the preferred embodiment sill be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Specifically, the present invention can be used to navigate the tourist to and within tour sites using an invented Visual Navigation method, and provides detailed multimedia narrations on objects along the tour. The system also navigates the tourist to other tourist destinations such as hotels and restaurants.

The principles and operation of a system and a method according to the present invention may be better understood with reference to the drawings and the accompanying description, it being understood that these drawings are given for illustrative purposes only and are not meant to be limiting, wherein:

Mobile Subsystem

General Flow

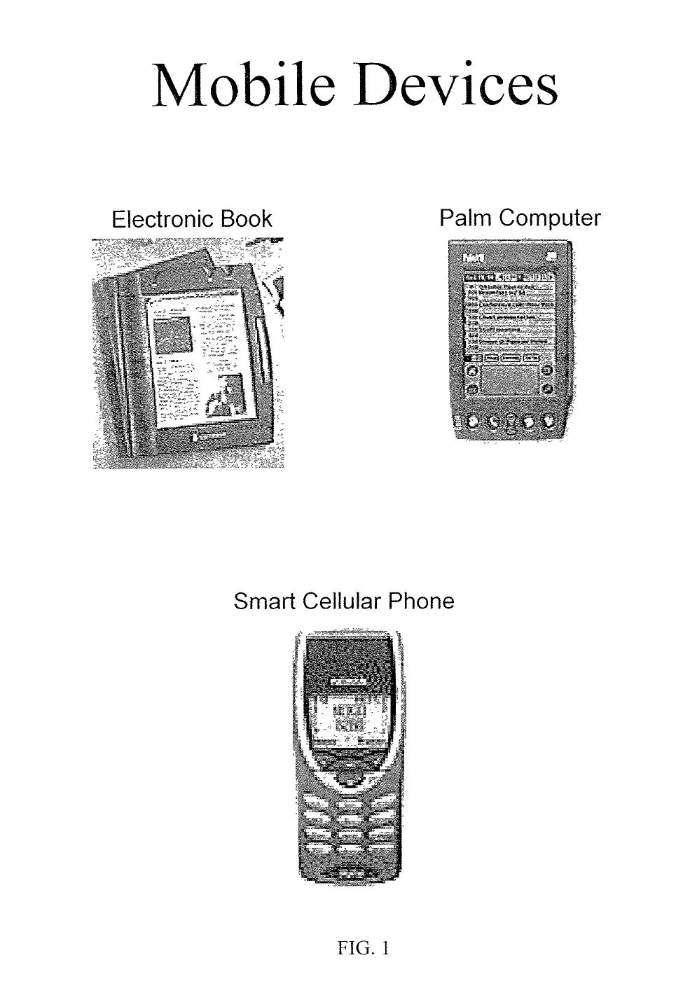

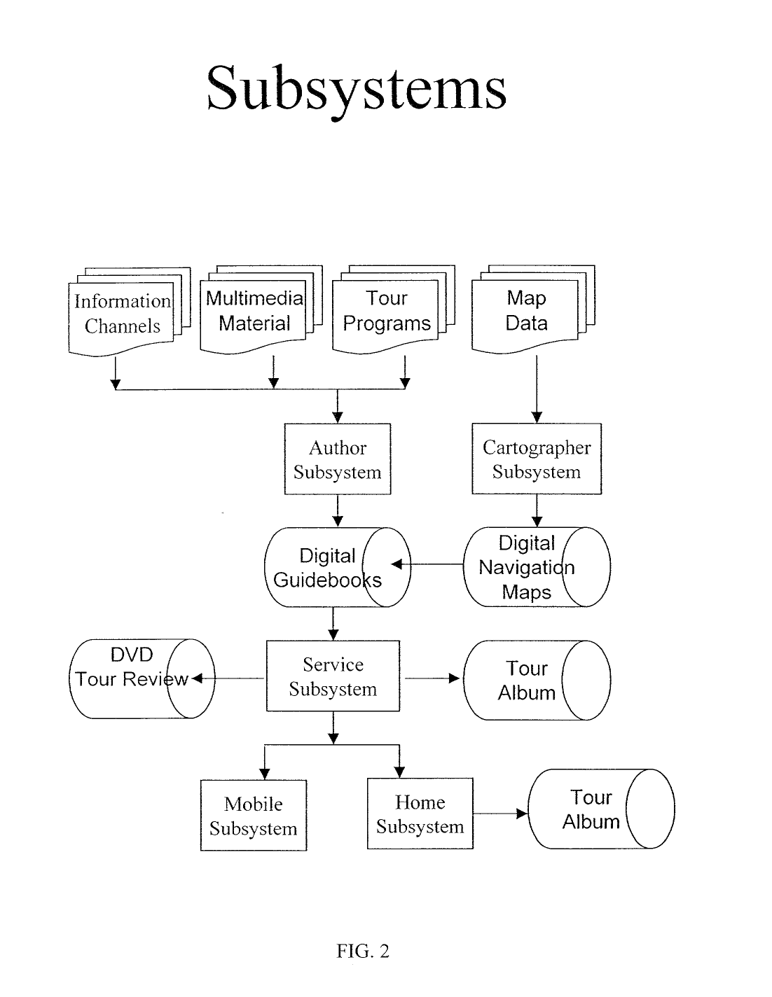

The mobile part of the Electronic Tourist Guiding system is designed to reside in commercial mobile computing devices and adapt its functionality to what is supported by the various devices: computing poster, memory capacity, presentation means, user controls, and communication means. Specifically, the system is designed for three types of mobile devices, as illustrated in FIG. 1.

1. Electronic Books

2. Palm Computers and Personal Digital Assistants

3. Smart Telephones

4. Wearable Computers

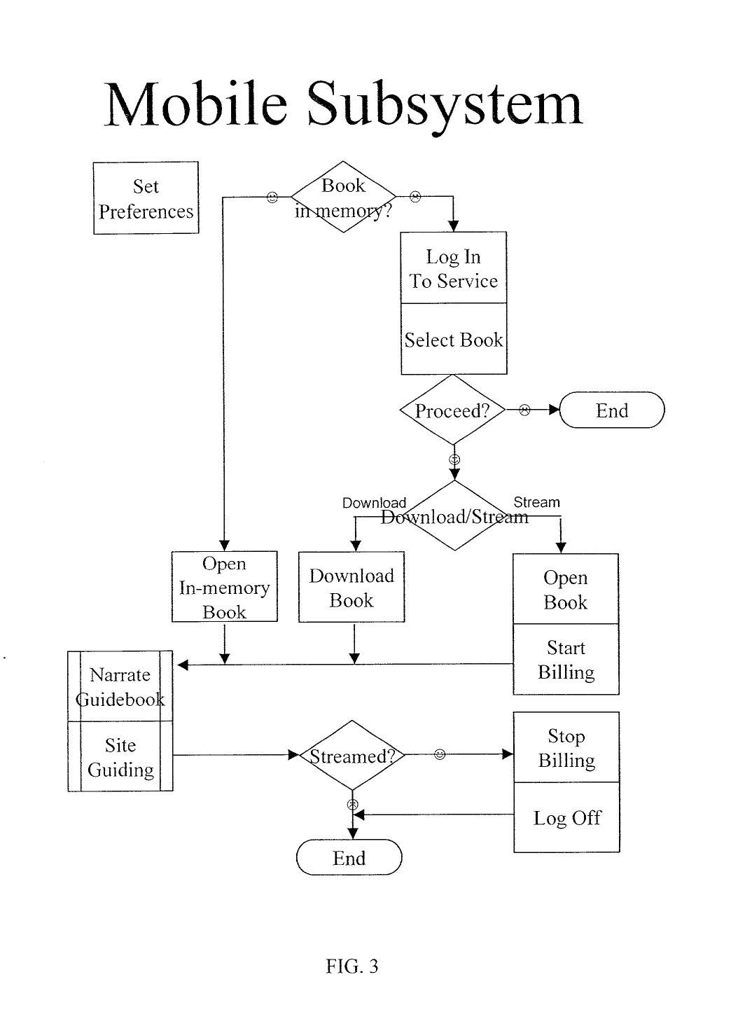

FIG. 3 illustrates the general flow of the tourist application: the mobile device typically includes multiple applications (address book and date book to mention a couple), thus the user first selects the electronic tourist guiding application. At this point, as well as at any other time, the user can setup his tour guiding preferences. The main action though is to open a guidebook and start the tour guiding. If the guidebook is in memory (i.e. has been purchased and loaded in), the book is ready to open. Otherwise, the user needs to either purchase the book from the Service or purchase Online Guidance for the duration of the tour. Digital Guidebooks can also be downloaded through the user's home computer to the mobile device. In the case of Online Guiding, the Service may start billing at this point.

The Electronic Tourist Guide system begins with an introduction to the guidebook content and structure by invoking the Narration Module. The method of providing an introduction to a guidebook, narrating a tour site, or narrating an object is identical in all cases and will be described later. The system then moves on to the actual tour guiding by invoking the Site Guiding module. When guiding is no longer needed, the user exits the application, and billing, if started, stops.

Guiding Concepts

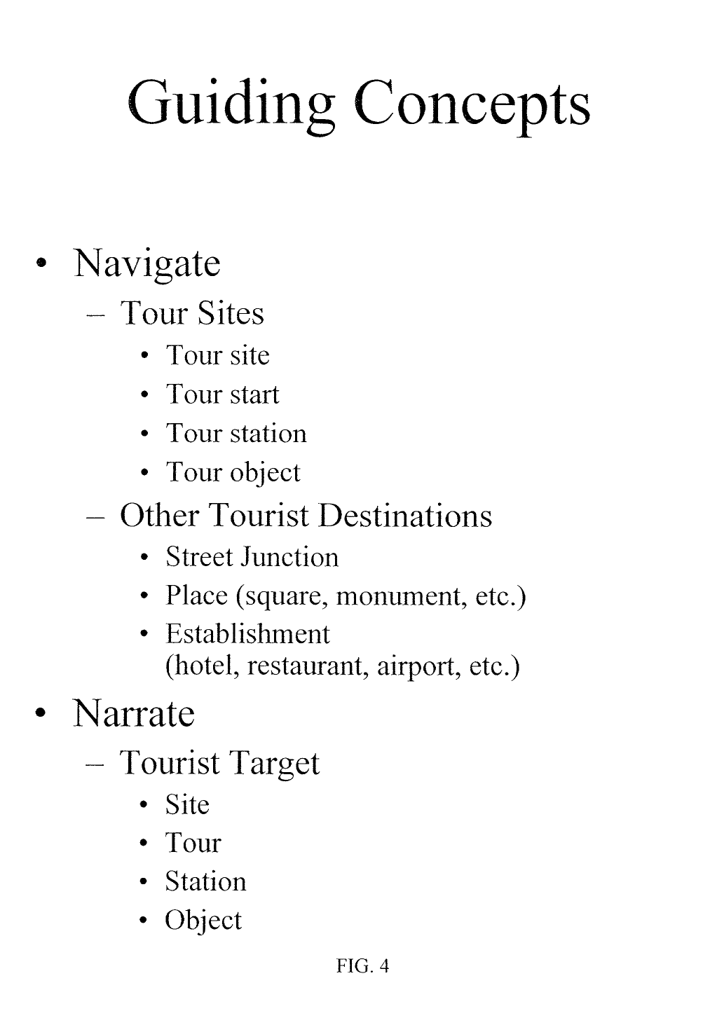

FIG. 4 outlines the guiding concepts. Guiding is made of alternating Navigation and Narration steps.

Navigation includes the actions that the tourist takes to physically arrive at the destination. The navigation system navigates the tourist to two types of destinations: tour sites and objects, and other tourist destinations.

A tour site could be a palace, a museum, a monument, and alike. Large sites are further divided to a series of stations that make up a tour. A station is a point where the tourist stops to get narrations, for example a room in a museum. Larger sites may include more than one tour to choose from. From a station the tourist's attention is drawn to one or more objects of interest, for example a painting in a museum room. The navigation system guide the tourist first to the site itself (or main entrance where applicable), then to the starting point of the chosen tour, then from one station to the next, and within each station—from one object to the next. Details on the method of navigation are provided later.

Other tourist destinations are of four types:

(1) Reference destination (‘Am I here?’)

(2) Street junctions (e.g. guide me to 58^{th} street and 7^{th} Avenue)

(3) Place (e.g. navigate me to Time Square)

(4) Establishment of various categories such as hotels, restaurants, and theaters

For tour sites, guiding alternates between navigation and narrations steps. When reaching a tour site, the tourist is given a general narration on the site. Then the tourist moves on to tour start and given a general narration on the tour. Then at each station—a narration on the station, followed by narrations on each object, and so on until the tour ends. The user can skip narration or navigation at any point and resume it at any point. Moreover, narrations are offered in different media and in different depths and topics of interests from which the tourist can choose.

Navigation and Narration Flow

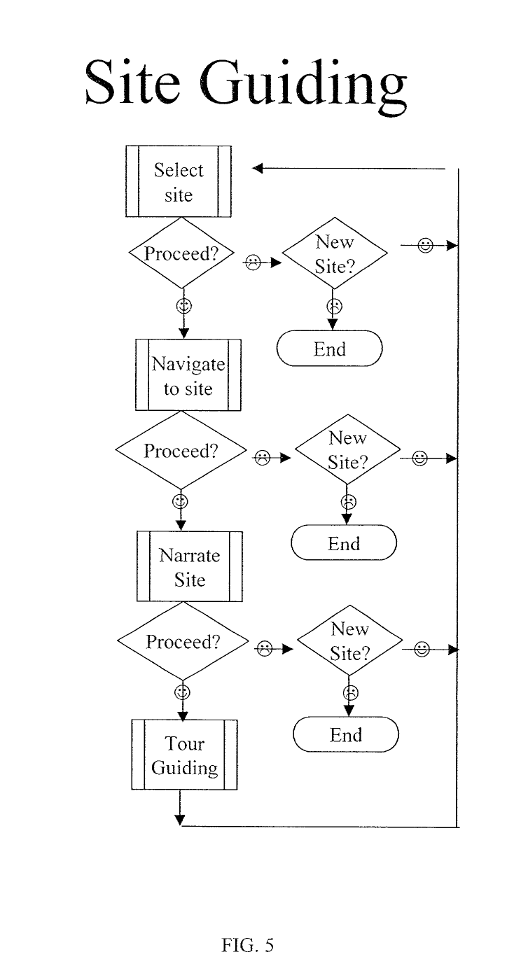

FIG. 5 describes the Navigation-Narration flow at a tour site.

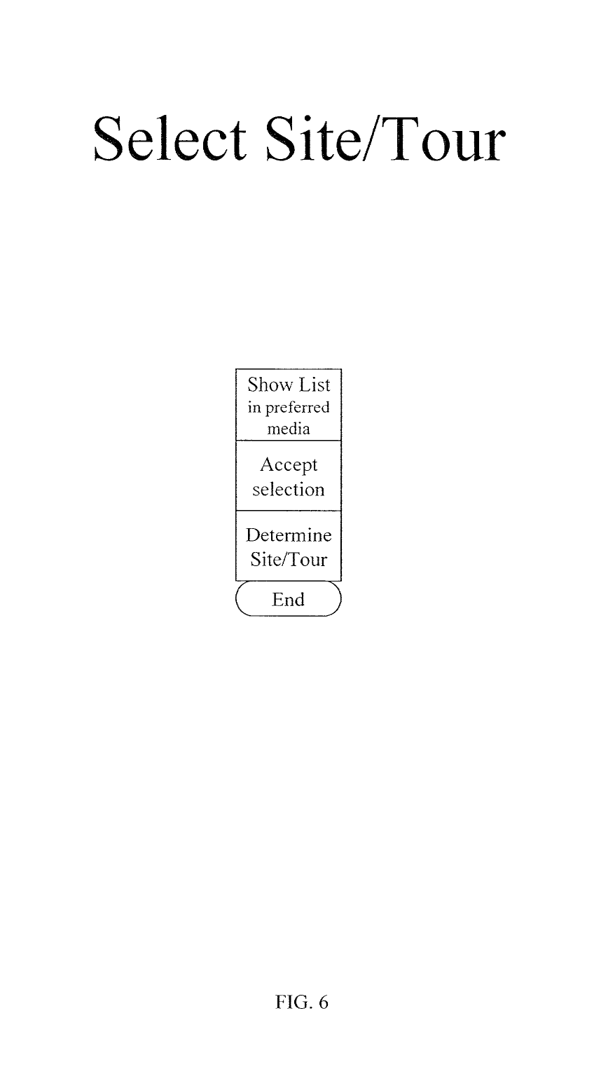

The first step is selecting the site to tour—see FIG. 6. The tourist is presented with a list of sites. The form of presentation depends on the mobile device's capabilities and the user's preference settings. The common presentation may be a display of site titles. Other forms include voice titles, highlights on the area map, and photo snapshots of the sites. The tourist then makes his selection or, optionally—exits. Controls for selection and exiting vary in different devices but users are familiar with the controls of their own device. Based on the tourist's selection, the system determines its next move. The very same process is employed when selecting a tour among multiple tours at a site. Back to FIG. 5, unless the tourist has chosen to exit or select another site, the system proceeds to navigating the tourist to the selected site. Navigation ends when the tourist confirms that he has arrived at the site. Navigation could also be aborted at any time to chance destination or quit touring altogether.

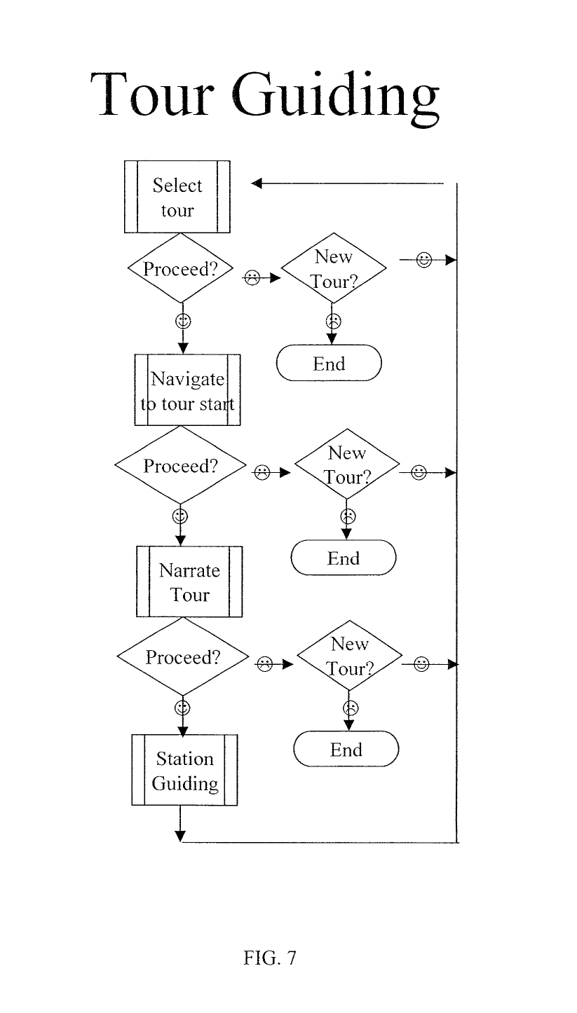

Once the tourist has arrived at the site, the system provides general narration on the site. The media and depth of narration depend on the features of the mobile device and the tourist's preference, varying from audio-visual narration to video to Enhanced Reality narration. The tourist can freely skip any narration and resume it at any time. When completing general narration on a site, the system now moves on to tour guiding. which is very similar to site guiding. See FIG. 7. The tourist first selects a tour (if more than one tour is available at the site). The system then navigates the tourist to the starting point of the tour and there provides general narration on the selected tour.

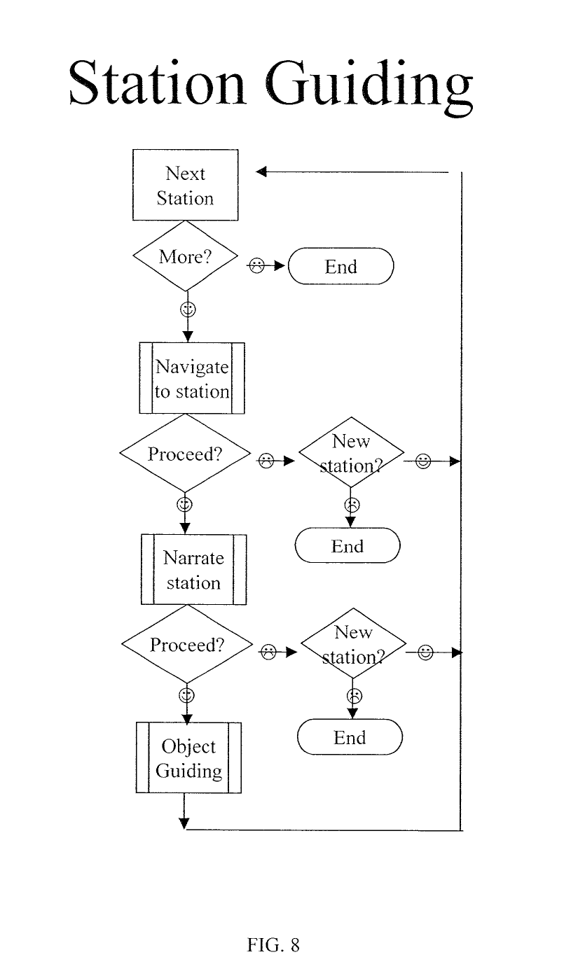

Then, the system moves on to station guiding. See FIG. 8. The only difference between tour guiding and station guiding is that the sequence of stations is predetermined and the tourist does not get to select which station he wants to visit next. The system navigates the tourist to the first station, narrates the station provides object guiding, and moves on to the next station. The tourist can skip a station any time to move on the following station.

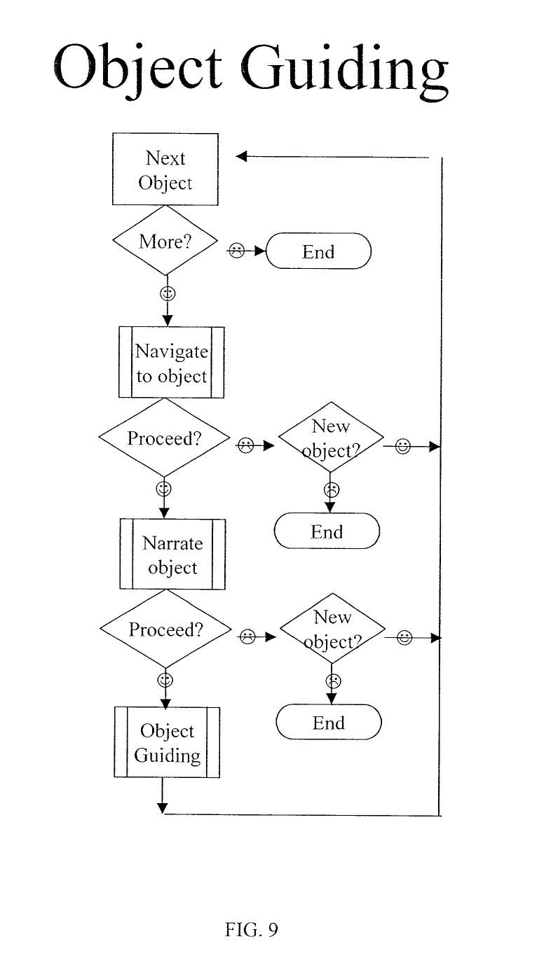

Object guiding is very similar to station guiding. See FIG. 9. After providing general narration at the station, the system navigates the tourist to the first object at the station (navigation here could simply mean drawing the tourist's attention to a painting on the wall), provides narration on the objects, and moves on to the next object until the last object is explained.

Narration Method Details

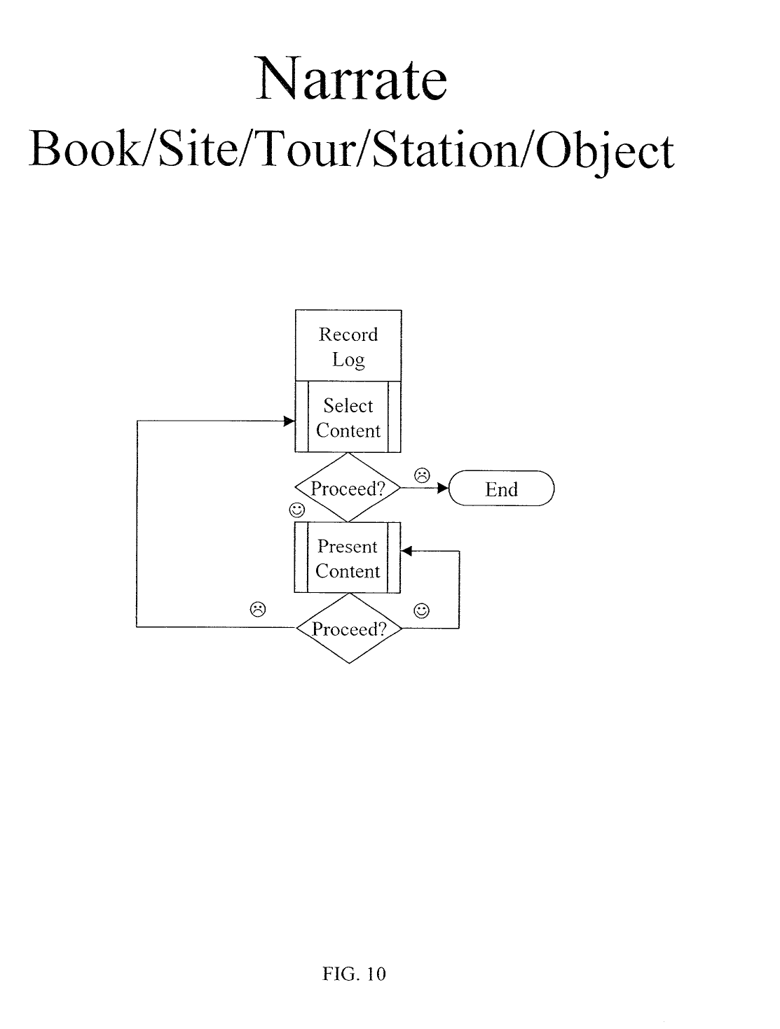

FIG. 10 details the process of narration. The system is programmed to provide narrations at five different occasions: when the tourist opens a Digital Guidebook, when he arrives at a tour site, when he arrives at a tour start, when he arrives at a station, and when he arrives at an object. The system determines at which object, station, tour, or site the tourist is located and provides the appropriate narrations from the Digital Guidebook. If the tourist is in logging mode (this feature is described in more details under Tour Album), a record of visit is added to the log.

The Digital Guidebook is organized naturally by sites, tours, stations and objects. Narrations for each such destination are further broken down to topics: a GENERAL topic and optionally orientation topics such as ART and HISTORY. Thus, the tourist is first presented with a list of topics to select from and then narration is provided for the selected topic. The tourist can interrupt narration and resume it at any time. If only one topic (GENERAL) is found, the system starts narration right away. In preference settings, the tourist can ask in advance to select specific topics, ART for example, to avoid repeated selections.

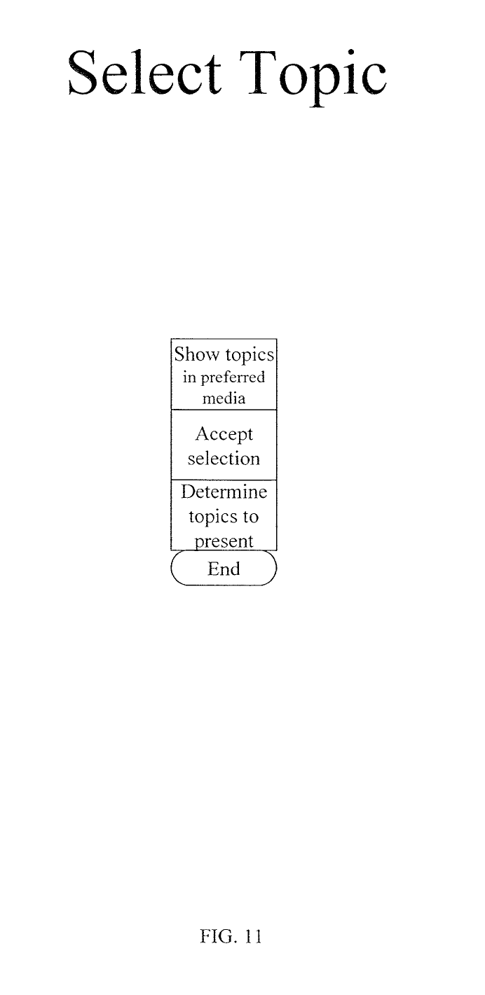

FIG. 11 details the process of topic selection. The list of topics is presented in the media of choice as determined from the features of the mobile device and the user's preference setting. The most common form is a textual list. Other forms include a voice menu and graphical selections.

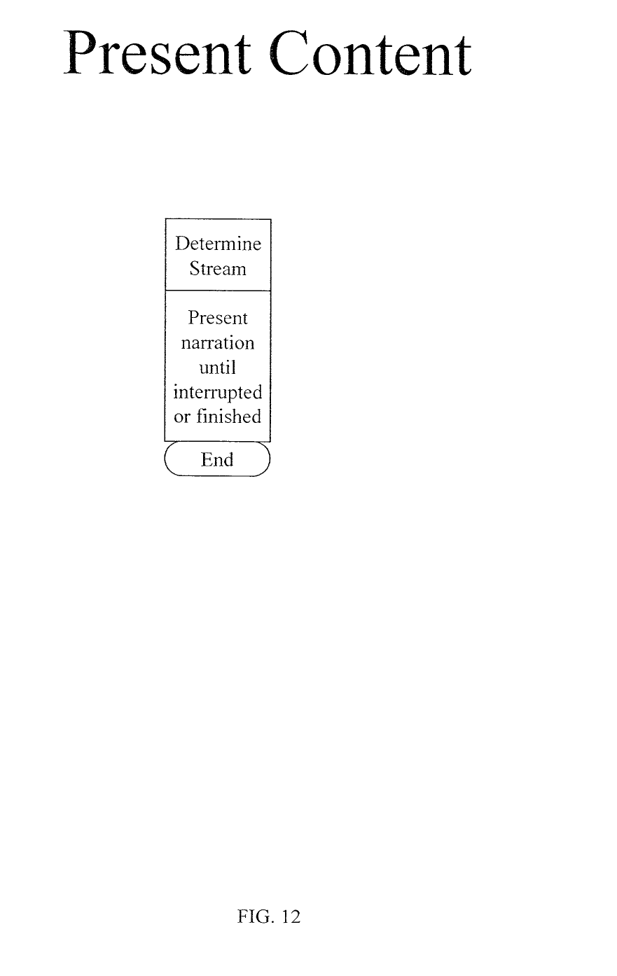

Once a topic is selected (GENERAL is the default), narration is given in the available and preferred media. See FIG. 12. The Digital Guidebook author prepares the narration material in all supported media, sometimes with redundancy since different guidebooks are built for different mobile devices. More details are found in Author Subsystem.

Back to FIG. 10, after narration is fully presented or interrupted, the user can select a new topic for the list, or exit.

Navigation Method Details

The invented Visual Navigation method satisfied the following design objectives:

1. The main purpose of visual navigation is to arrive at each tour object within a site. A secondary purpose, in the absence of GPS or CPS navigation, is to arrive to the site and to other tourist destinations such as hotels and restaurants.

2. The tourist moves around the site by foot. Passenger tourists can use the navigation system as well but it's mainly designed for pedestrians.

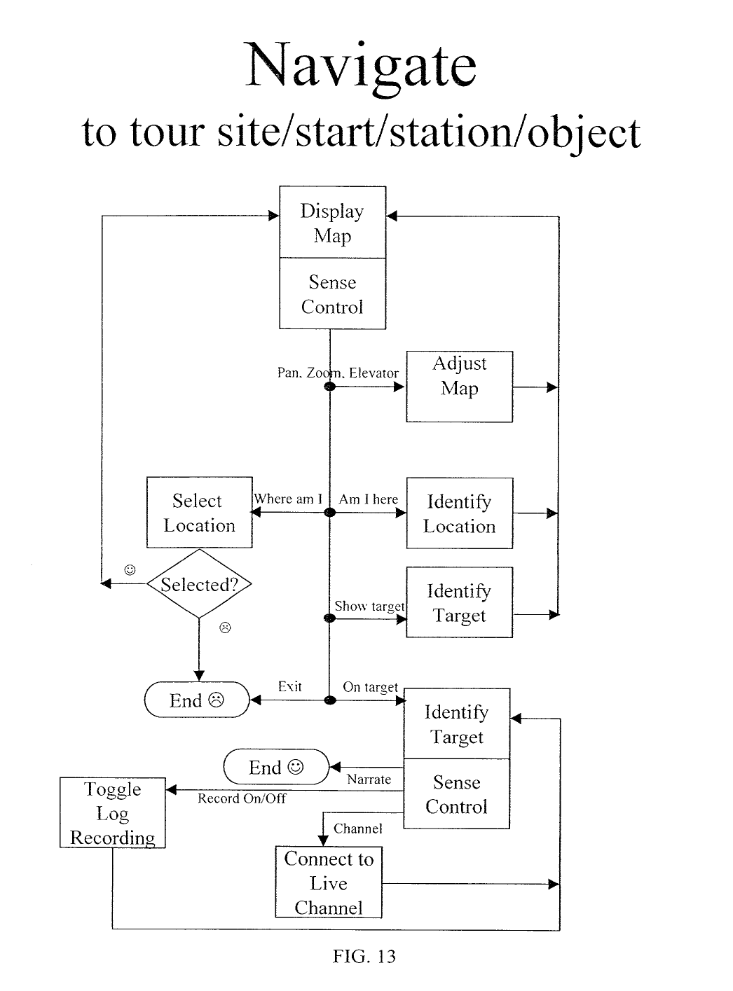

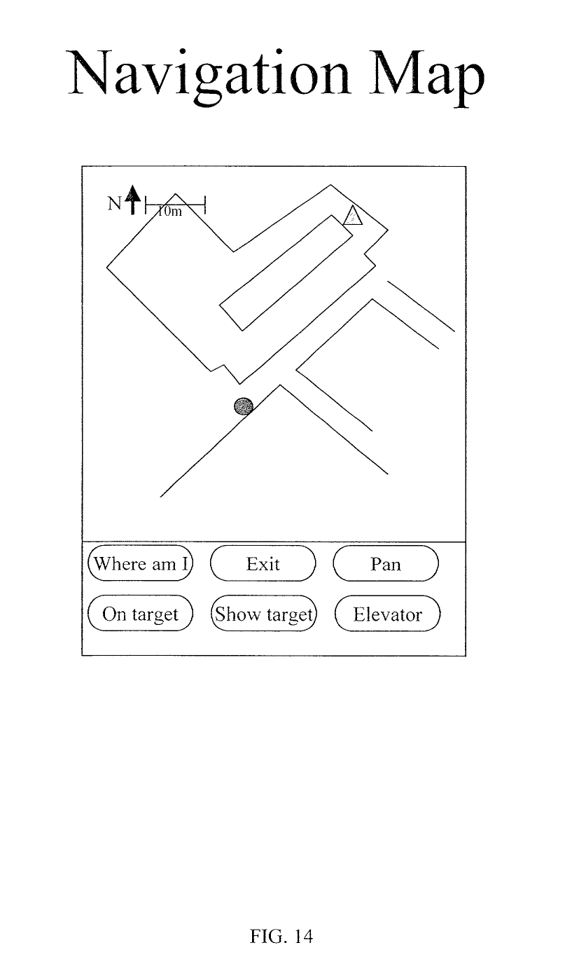

FIG. 13 describes Visual Navigation in details. Most navigation activities are done on a Digital Navigation Map, illustrated in FIG. 14. In general, two points are highlighted on the map: a red circle indicates where the tourist is now (or thinks he is), and a green triangle indicates the next target: site, tour start, station, or object. The goal is to bring the red circle over the green triangle. The Navigation Map includes navigation controls that help the tourist reach his target: Zoom, Pan, Elevate. ‘Am I here’, ‘Where am I’. Show Target, and On Target. All controls except for one are operated by soft buttons. ‘Am I here’ is operated by tapping the map area.

Back to FIG. 13, the system senses the last tourist control and reacts accordingly:

Zoom, Pan, Elevator

Zoom and Pan are common map controls. Zooming in and out changes the scale of the displayed map. Pan changes the center of the displayed map. Panning is done by clicking on the Pan control and pointing to the new center of the map. Elevator swaps between multi-layered maps, for example a museum with multiple floors.

‘Am I here?’

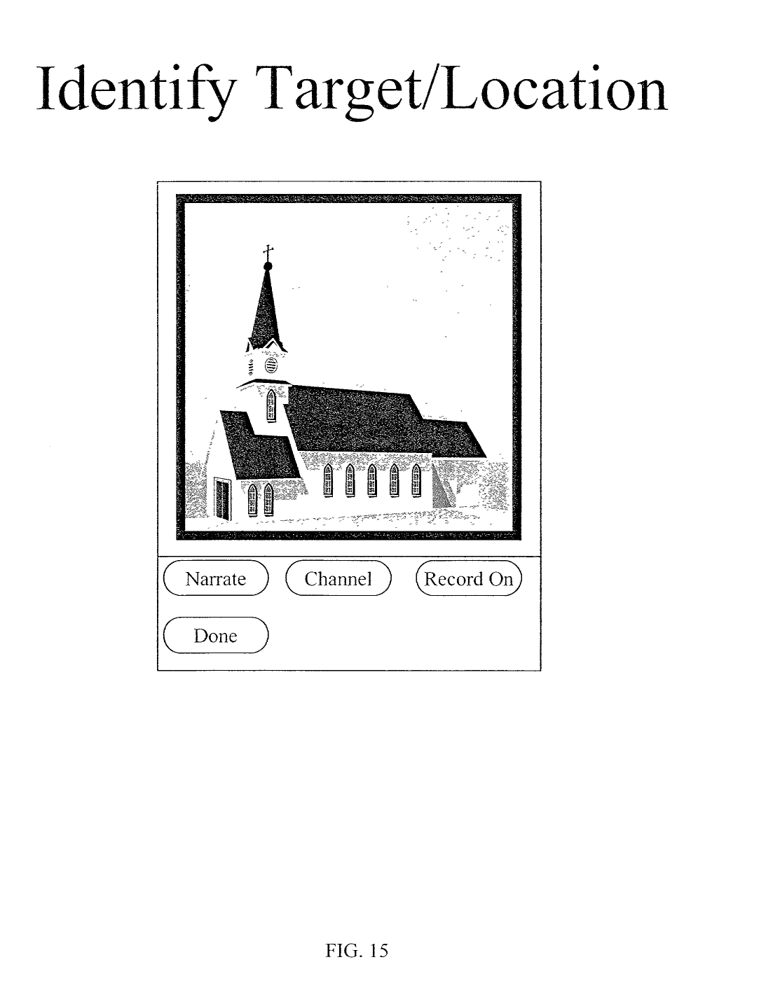

As the tourist advances toward the target and wants to confirm his place, the taps on the map at the point he thinks he is now. The system replies by displaying a visual of a nearby recognizable reference object, such as in FIG. 15. The author may designate the reference objects. All tour destinations serve as reference objects but in large sites the author may designate additional reference objects that are not tour destinations. See Author subsystem for details. When the picture of the reference object is displayed, the tourist can visually compare it to what he sees around and decide how to proceed.

‘Where am I?’

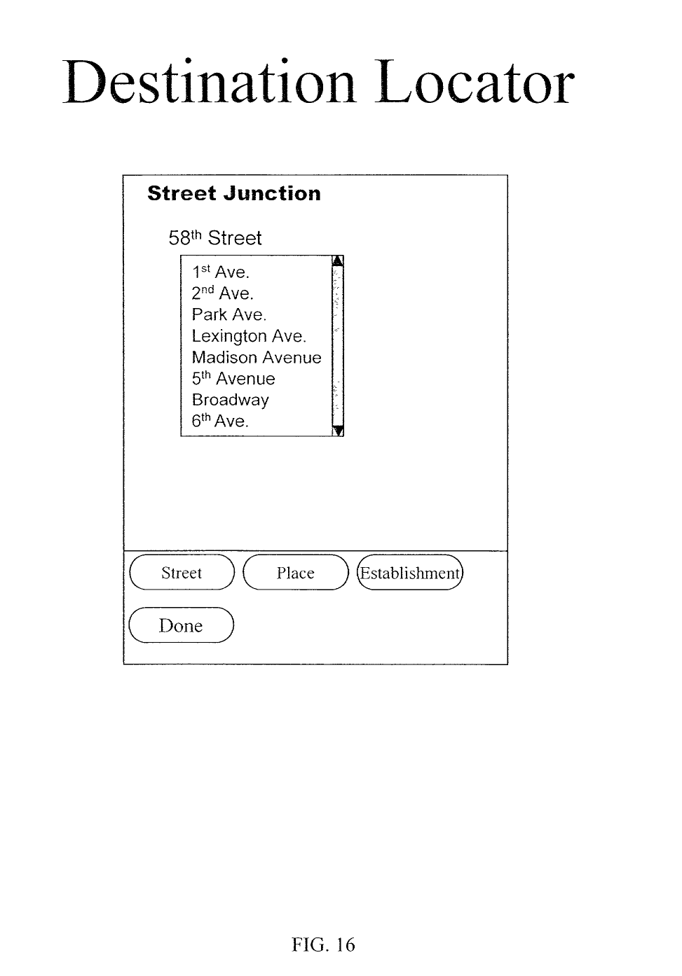

When the tourist taps on ‘Where am I?’ the system displays a destination locator as in FIG. 16. With this locator, the user selects a destination from a destinations directory and the system marks its place (with a red circle, indicating ‘You are Here’) on the Navigation Map. The system allows selection from three types of destinations: street junctions, named places, and establishments, each selected by tapping the corresponding button.

Locating a named place or an establishment is done in one step: an alphabetical directory of named places or establishments is displayed. When the tourist taps his selection, the system displays the Navigation Map, marking the selected destination on the map by a red circle.

Locating a street junction is done in two steps: first—an alphabetical directory of streets is displayed. When the tourist taps (selects) a street, a directory of all crossing streets of the selected street is displayed. Each such crossing street is a junction. When the tourist selects a junction, the system displays the Navigation Map, marking the selected destination on the map by a red circle.

Show Target

At any time the tourist can ask the system to show a visual of the target. This aid is useful when the tourist thinks he can see the target from where he is now and proceeds directly to it without further navigation assistance.

On Target

When the tourist is finally at the target, he indicates so by tapping ‘On Target’. At this point the target is displayed and the tourist is presented with a number of controls (see FIG. 15):

Narrate: the system begins its narration and then proceeds to the next target.

Channel: if active, the system channels live information from the linked Internet channel. The control is active if (a) the destination has a hyperlink to an Internet channel and (2) the mobile device is connected to the Internet.

Record on/off: toggle between the two log recording modes. See Tour Album for more details.

Navigation To Tour Sites And Other Tourist Destinations

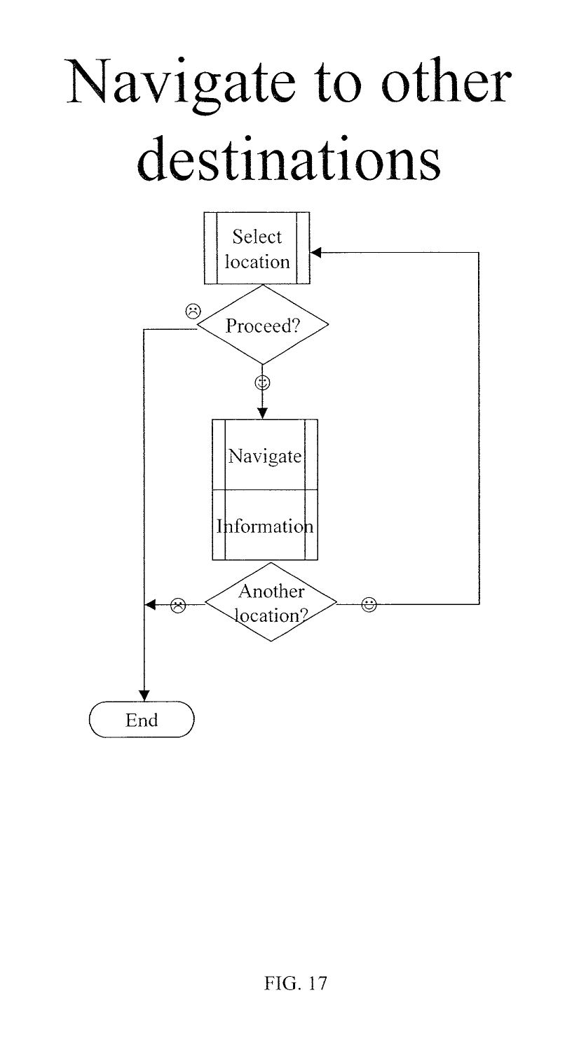

In addition to navigating at tour sites to receive narration on sighted objects, the tourist can also use the same Visual Navigation system for navigating to other destinations such as hotels, restaurants, shops and theaters. An additional embodiment of the present invention may allow GPS and CPS navigation for this purpose. Visual Navigation to tourist destinations is described in FIG. 17.

Navigation starts with selecting the destination. The system displays the same Destination Locator used for tour navigation (see FIG. 16). The selected point is marked on the Navigation Map by a green triangle, designating a target. The user marks his present point with a red circle as he did in tour navigation and proceeds as usual. The tourist can optionally (depending on the author choice) receive information about each destination, similar to the narrations of tour sites, including Internet channels to live information. For example—a restaurant might advertise on its Internet channel opening hours, menus of the day and other items of interest to the tourist.

Channels To Live Information

When the tourist has arrived at a destination (tour site or other tourist destinations) he can open an Internet channel to receive live, timely information from that destination. This can only be done if the author has defined an Internet channel for that destination and the mobile device is connected to the Internet.

Tour Album

The Mobile subsystem is programmed to record a log of visits at tour sites in order to later create a Tour Album. However, it's the tourist who controls when recording begins and when it ends by use of ‘Recording On’ and ‘Recording Off’ toggle control. Actual recording of the log takes place when a tourist visits a target—site, station, or object. The mobile subsystem only records the date and time of the visit and a bookmark to the Digital Guidebook. The recorded information is later uploaded to the Home subsystem or the Service subsystem for creation of the Tour Album.

Armchair Touring

The tourist doesn't physically have to visit the tour site in order to receive tour narration. Instead, he can virtually navigate to the site, tap on the ‘On Target’ control and receive the same narration. This method of guiding is called Armchair Touring. Armchair touring is better done on the Home subsystem since it support richer multimedia.

Home Subsystem

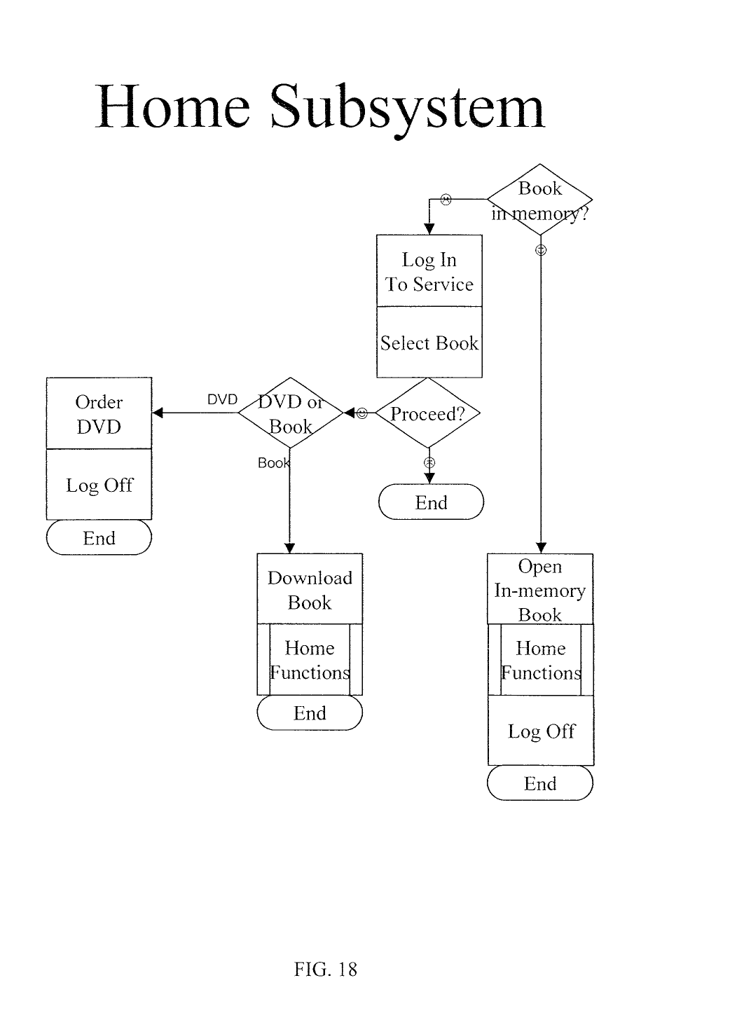

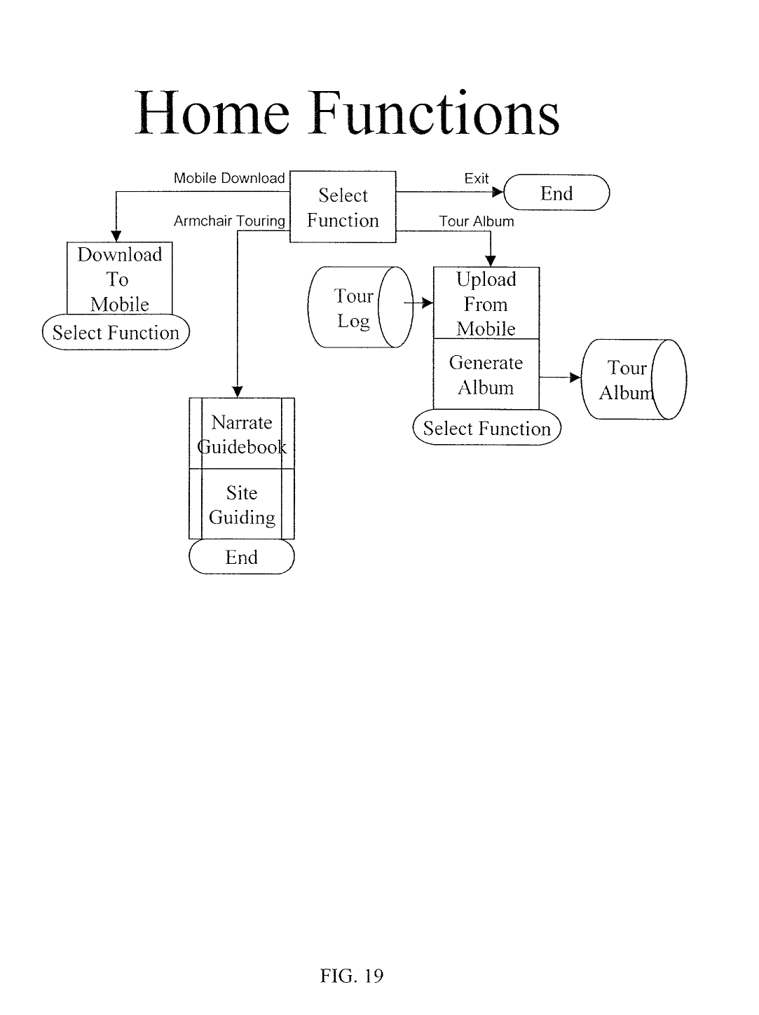

The home subsystem provides three auxiliary tourist functions: fast download of Digital Guidebooks to the mobile device; large screen presentation of a multimedia Armchair touring: and creation of Tour Albums. None of the function is mandatory and the tourists can enjoy Electronic Tourist Guiding without buying the Home subsystem. FIG. 18 describes the general flow of the Home Subsystem. FIG. 19 describes in details the three functions of the Home Subsystem.

Fast Download

At times, downloading a Digital Guidebook from the Service to the mobile device might be faster through the Home subsystem. Mobile devices have wired connections to home computers, and home computers have very fast Internet access.

Armchair Touring

Armchair touring in the Home subsystem is similar to that in the Mobile subsystem. However, since the media of narration for home computers is richer than that of mobile devices and the screen is larger, armchair touring is more rewarding. Moreover, since the Home subsystem does not support navigation, all navigation steps are automatically skipped.

Creation of a Tour Album

Creation of a Tour Album is done either in the Server Subsystem or in the Home Subsystem if purchased. FIG. 19 describes the process. The Home or the Service Subsystem first uploads the tour log from the Mobile subsystem. It then copies relevant pictures from the Digital Guidebook, imprints on them the timestamps from the log, and creates the Digital Tour Album. The album can be viewed and edited by the tourist at any time with common imaging tools.

Author Subsystem

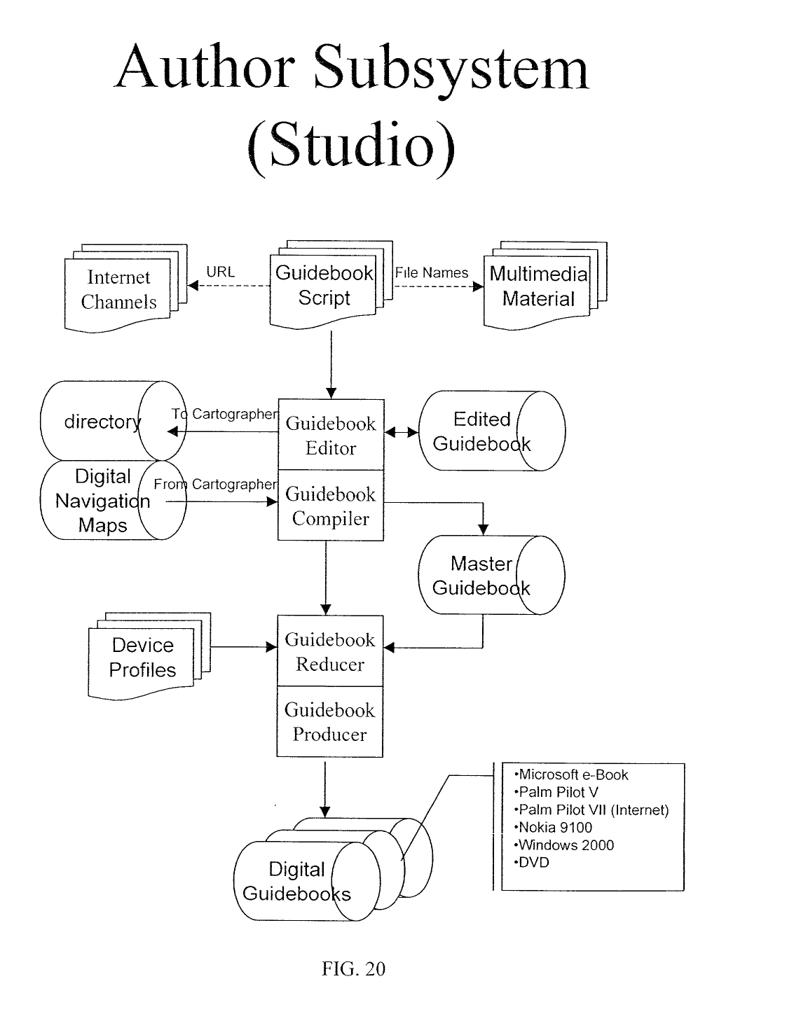

FIG. 20 describes the Author subsystem, also called the Studio. The Studio is designed for high power workstations with large screens and memory for handling multimedia content. The Studio allows the editing of full-feature Digital Guidebooks. The full-featured, Master Guidebook is then reduced to match the capabilities and capacities of different mobile devices thus simplifying the production and revision of multi-version Digital Guidebooks. In addition to multimedia narrations on tour sites, Digital Guidebooks also include Digital Navigation Maps created by the Cartographer subsystem and Pictures—drawings or photos of recognizable reference objects along the tour path, both needed for Visual Navigation. Digital Guidebooks additionally contain Internet channels—hyperlinks to live, timely information on tourist destinations.

Guidebook Script and Editor module

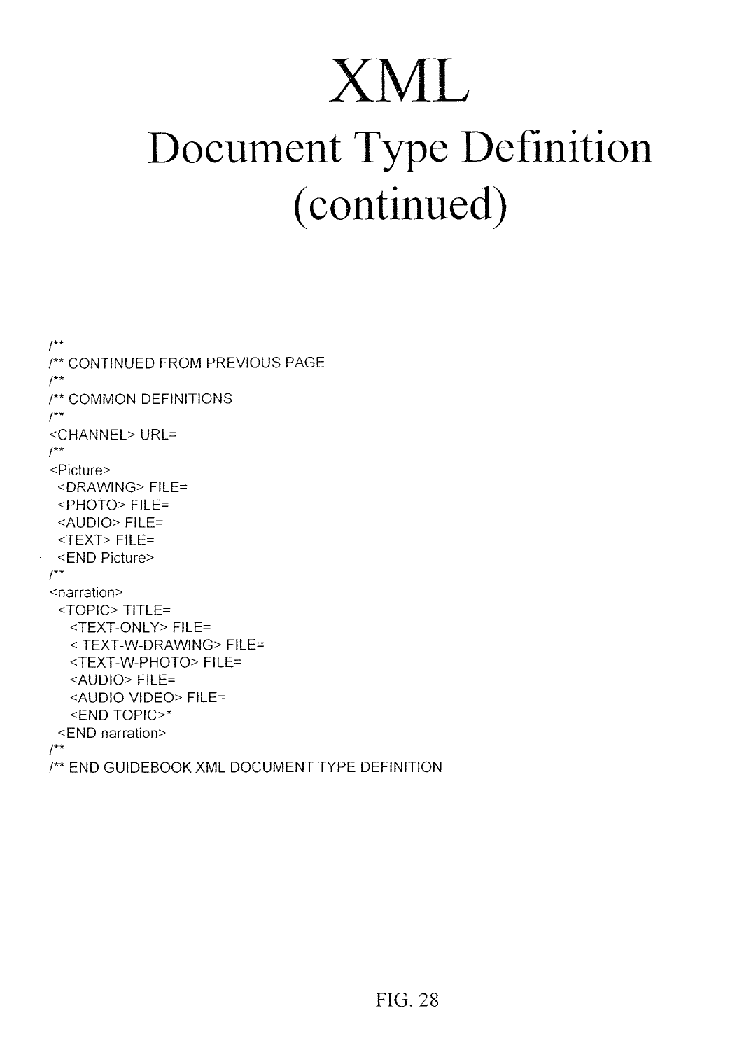

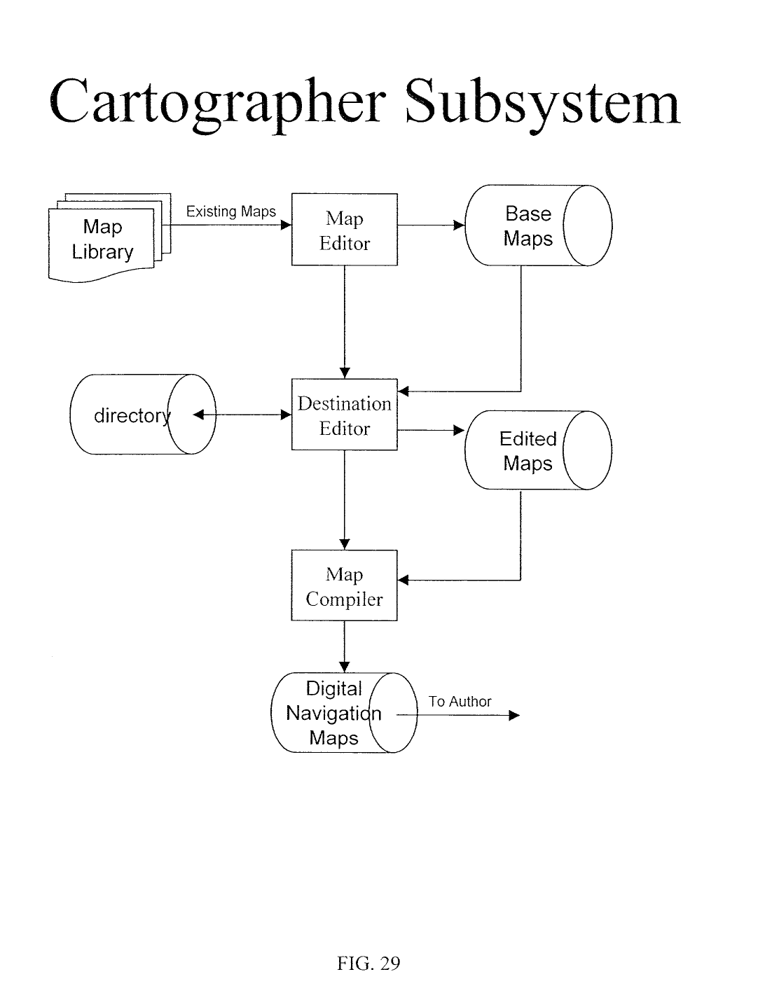

The raw material with which the author is working is the Guidebook Script. The preferred script language is XML (Extensible Markup Language) with special markup tags for tourist vocabulary, however other script languages could be supported in future extensions to the system. FIG. 28 and FIG. 29 list the XML Document Type Definition for a Guidebook Script. The Guidebook Editor module is a revised XML script editors tailored to the specific vocabulary and features of the system. Reference to destinations is done through destination names and destination codes. Reference to Internet channels is done through URL (Internet hyperlinks). Reference to multimedia material is done through file names. The author can browse through the edited guidebook at any time and make editorial changes—add, delete, replace, etc. The Guidebook Editor module allows script level testing, that is—the author can play the role of a tourist at any time without the need to leave the editor module environment.

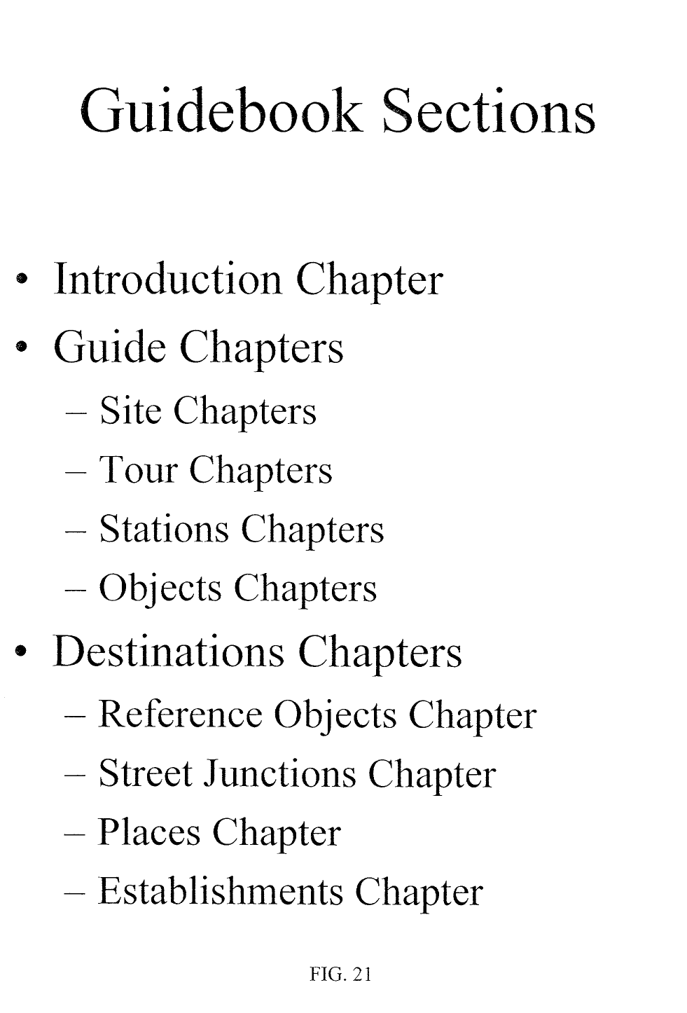

A Guidebook Script is made of chapters. There are three groups of chapters, as outlined in FIG. 21:

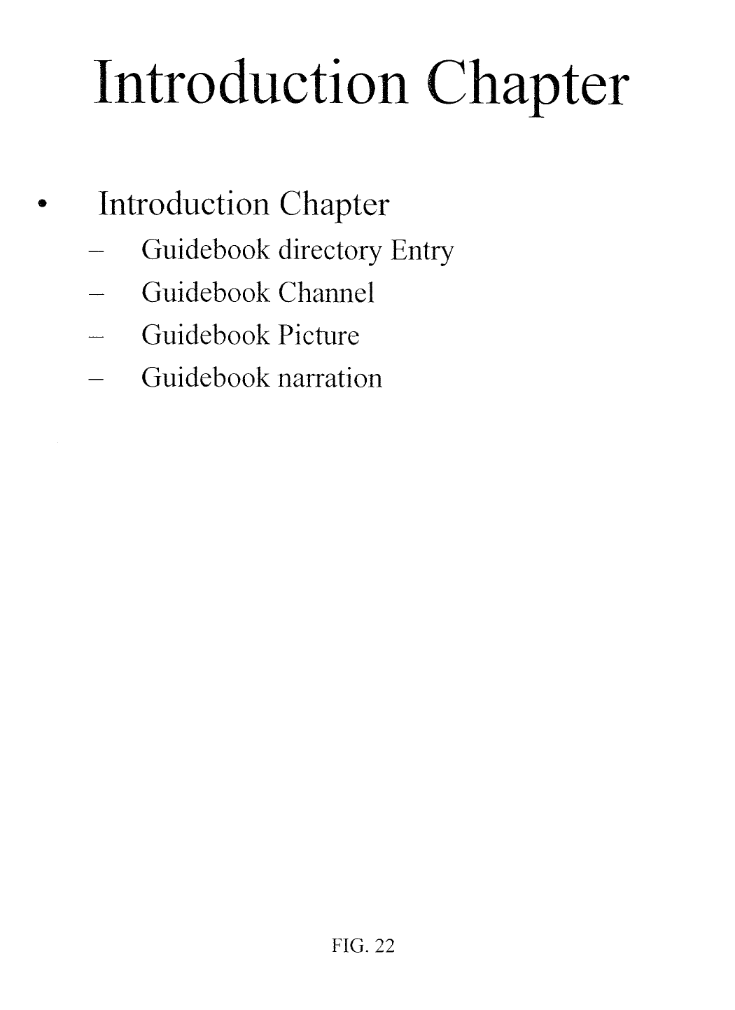

Introduction Chapter: the first chapter in the Guidebook Script. It contains general information about the guidebook, as outlined in FIG. 22.

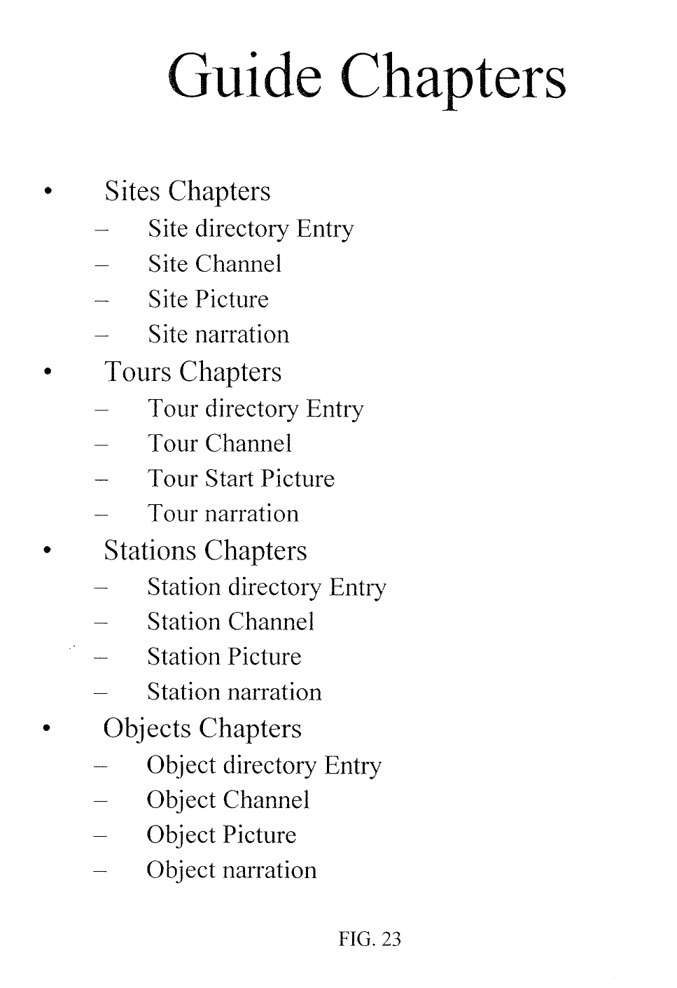

Guide Chapters: contain site guidance information. Each site is described in a separate Site Chapter. Each Site Chapter is divided to Tour Chapters, then to Station Chapters and to Object Chapters, hierarchically. The structure of each Guide Chapter is very similar as outlined in FIG. 23.

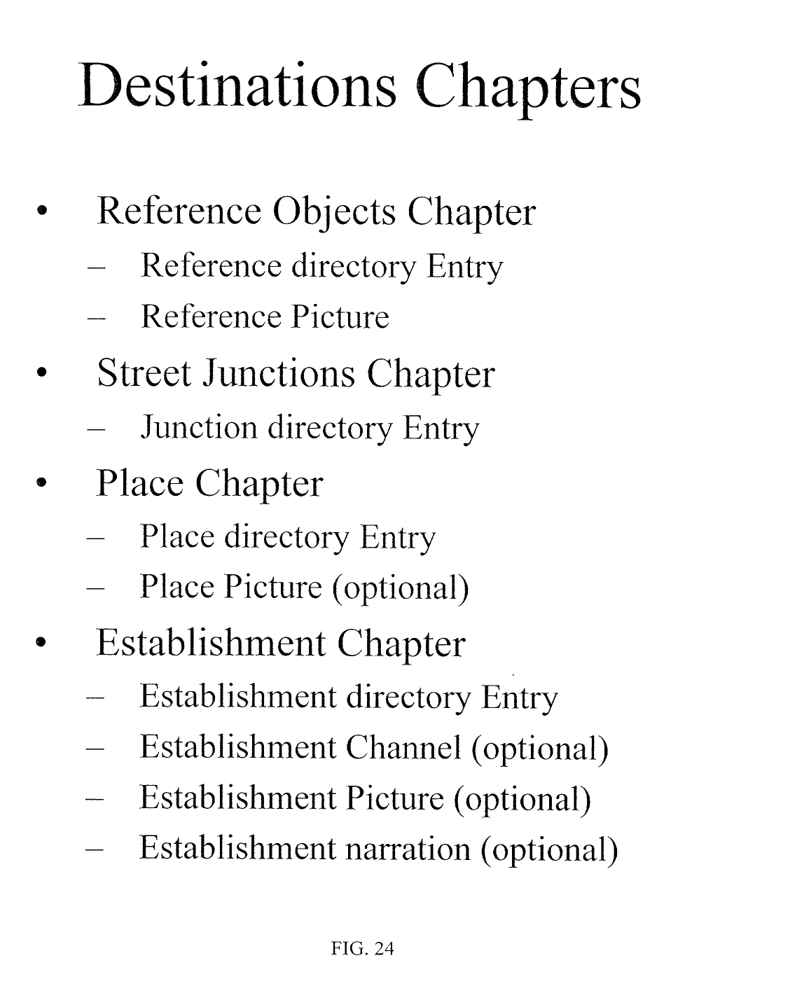

Destination Chapters: contain information about other tourist destinations. There are four Destinations Chapters as outlined in FIG. 24:

Reference Objects Chapter: contains navigation reference objects. Used for the ‘AM I Here?’ control.

Street Junctions Chapter: contains street junction destinations. Used for the ‘Where Am I?’ control and for navigation to tourist destinations.

Named Places Chapter: contains named place destinations. Used for the ‘Where Am I?’ control and for navigation to tourist destinations.

Establishments Chapter: contains named establishment destinations. Used for the ‘Where Am I?’ control and for navigation to tourist destinations.

Optionally contains information on and Internet channels to destinations. The information on each destination—tour site, tour object, establishment, etc is organized in four parts:

Director Entry

Channel

Picture

Narration

The following describes each part of information:

Directory Entry

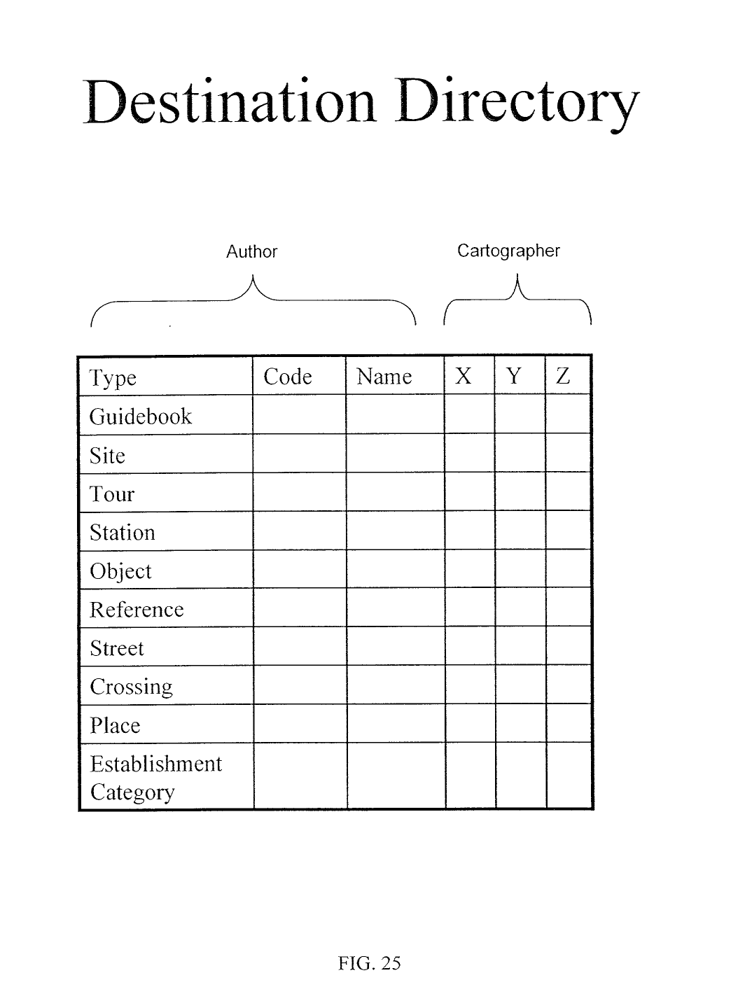

Each destination in the Digital Guidebook (tour object, tourist destination, reference object, etc.) has a unique entry in the Destination Directory. The Destination Directory is a six-column table that is shared between the author and cartographer to synchronize navigation with narrations. The author is responsible for three columns—Destination Type, Destination Code, and Destination Name, and the cartographer is responsible for the three other—X, Y, and Z coordinate columns as illustrated in FIG. 25.

The following describes each column:

Destination Type: matches the chapters of the Guidebook Scirpt, for example—Site, Station. These are explained in details for each chapter.

Destination Name: an alphanumeric long descriptive name of the destination. A name does not have to be unique in the book and is understood by the tourist by context. In multilingual guidebooks names may be spelled differently in different languages.

Destination Code: an encrypted code that is unique in the book and is used only by the author, the cartographer, and the system. In multilingual guidebooks the code remains unchanged between languages.

X,Y,Z: destination coordinates. (Are explained in the Cartographer subsystem).

Internet Channel

Some destinations have an Internet Channel to live information. An Internet Channel is defined by its URL.

Picture

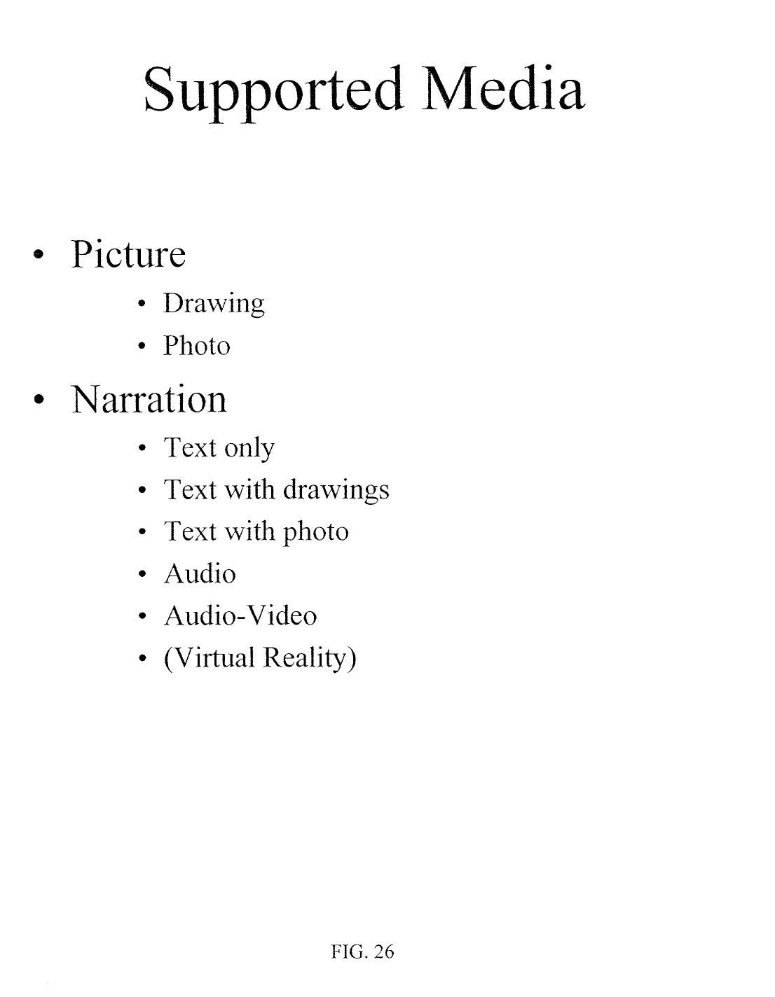

Used in Visual Navigation to verify that the tourist has arrived at this destination. Not all destinations necessarily have pictures. Pictures come in one or two media. See FIG. 26.

Drawing: name of an image file that contains a recognizable drawing of the destination

Photo: name of an image file that contains a recognizable photo of the destination

Narration

The narration part is divided to one or more topics. A mandatory topic for all tour site destinations is ‘GENERAL’—a topic that provides the minimal narration on the destination. Other topics are up to the author and intended to provide more orientated narrations, for example—‘HISTORY’ and ‘ART’ topics.

Under each title, narration is provided in up to five supported media. See FIG. 26.

Text: name of a text file that contains only textual narrations

Text with Drawings: name of a compound document file that contains textual narration enhanced by simple drawings

Text with Photos: name of a compound document file that contains textual narrations enhanced by photo images

Audio: name of an audio file that contains only audio narrations

Audio-video: name of an audio-video file that contains audio-video narrations

More advanced media such as enhanced reality narration supported in additional preferred embodiment of the present invention.

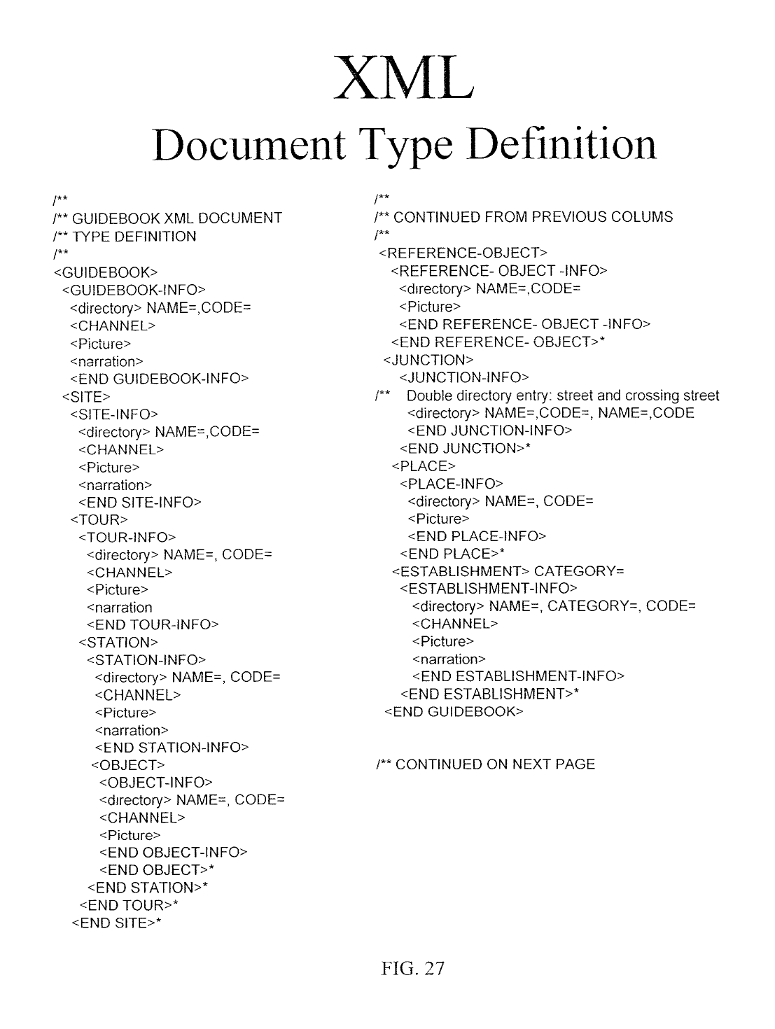

The following paragraphs describe in more details the chapters of the Guidebook Script. FIG. 27 contains a formal definition of this structure in the XML language.

Introduction Chapter

FIG. 22 outlines the structure of the Introduction Chapter.

Guidebook Directory Entry

Name: name of the guidebook

Code: internal code used by the publisher and the system

Guidebook Channel: hyperlink to the publisher Internet site to receive last-minute updates

Guidebook Picture: picture of the guidebook cover. Used to display the guide in the Service catalog.

Guidebook Narration

General topic. Provides a general description of the guidebook. Scripted for all defined media

Text

Text with drawings

Text with photo

Audio

Audio-video

Guide Chapters

Following in the Introduction Chapter comes a series of hierarchical chapters

Site Chapters

Tour Chapters

Station Chapters

Object Chapters

Collectively these chapters are called Guide Chapters. FIG. 23 outlines the structure of Guide Chapters.

Site Chapter

Site Directory Entry

Name: name of the site

Code: internal code used author, cartographer, and the system

Channel: hyperlink to the site to receive live information on the site

Site Picture: picture of the site for identification. Used to verify that the tourist has arrived at the site. Also used in the Tour Album. Available in two media: Drawing and Photo.

Site Narration

General topic. Provides a general narration on the site. Scripted for all defined media (text, text with drawings, text with photo, audio, audio-video).

Additional topics as determined by the author to provide more specialized narration on the site. Scripted for all five supported media.

After the site narration come a series of Tour Chapters, each narrating a tour within the site. The structure of a tour chapter is described in the following paragraph and is very similar to the structure site chapters.

Tour Chapter

Tour Directory Entry

Name: name of the tour

Code: internal code

Channel: hyperlink to the site to received live information on the tour

Tour Start Picture: picture of the tour start destination for identification.

Tour Narration

General topic. Provides a general narration on the tour.

Additional topics as determined by the author).

After the tour narration come a series of Station Chapters, each narrating a station in the tour. The structure of a station chapter is described below and is very similar to the structure site chapters.

Station Chapter

Station Directory Entry

Name: name of the station

Code: internal code

Channel: hyperlink to the site to received live information on the station

Station Picture: picture of the station for identification.

Station Narration

General topic. Provides a general narration on the station.

(Additional topics as determined by the author).

After the station narration come a series of Object Chapters, each narrating an object within the station. The structure of an object chapter is described below and is very similar to the structure site chapters.

Object Chapter

Object Directory Entry

Name: name of the object

Code: internal code

Channel: hyperlink to the site to received live information on the object

Object Picture: picture of the object for identification.

Object Narration

General topic. Provides a general narration on the object.

(Additional topics as determined by the author).

Destination Chapters

Following the Guide Chapters in the Guidebook Script comes four Destination Chapters: Reference Objects Chapter, Street Junctions Chapter, Named Places Chapter, and Establishments Chapter. See FIG. 24.

Reference Objects Chapter

A Reference Object is a point on the map that is only used to aid in Visual Navigation. The Reference Objects chapter includes a directory entry and a picture for each such reference object.

Reference object Directory Entry

Name: name of the reference object

Code: internal code

Reference object Picture—in two media: drawing and photo.

Street Junctions Chapter

A street name and a street crossing it, define a street junction. A street junction therefore occupies two directory entries—one for the street and one for the crossing street (preferred implementations may easily condense this apparent redundancy by removing duplicate entries).

Junction Directory Entry

Name: name of the street

Code: internal code for the street

Name: name of the crossing street

Code: internal code for the crossing street

Named Places Chapter

The Named Places Chapter contains named places such as squares and monuments, and includes the following information:

Place Directory Entry

Name: name of the place

Code: internal code

Picture (optional): picture of the place

Establishments Chapter

The Establishment Chapter contains such establishment as restaurants, hotels, shops and theaters, and includes the following information:

Establishment Category (Restaurant, Hotel, Shop, Theatre, etc.)

Establishment Directory Entry

Name: name: name of the establishment

Code (optional): internal code

Channel: hyperlink to the establishment Internet site to receive live information

Picture (Optional): picture of the establishment

Narration (Optional): narration on the establishment

Digital Guidebook Compilation

Back to FIG. 20, when the author is satisfied with the Edited Guidebook and the cartographer has produced his Digital Navigation Maps, the author can compile a Master Guidebook. Compilation is completely automatic with the Guidebook Compiler module although driven by various author options. The Master Guidebook comprises a directory tree of files for use by the Guidebook Producer module.

Digital Guidebook Reduction and Production

The Guidebook Producer module produces from the Master Guidebook multiple versions of the Digital Guidebook, each reduced to match the capabilities of a different device. A ‘Device Profiles’ script file that included profiles of all the supported devices drives the reduction process. Mobile devices are characterized by features such as computing power, memory size, screen size and resolution, audio capabilities, video capabilities, graphics capabilities, control means, communication capabilities (protocol, bandwidth, speed), and intended use. The profile of a device determines what parts of the full guidebook need to be included in the version for that device.

The reduced version of the Digital Guidebook is then formatted for use by the device operating system, ready to be stored in the Service subsystem for sale. Mobile target devices that are supported by the system are Electronic Books, Palm Computers and Smart Cellular Phones. Special versions of Digital Guidebooks are also created for the Home subsystem and for DVD Tour Reviews. In future extensions of the system. Digital Guidebooks for Wearable Computers are anticipated.

Cartographer Subsystem

The main purpose of the Cartographer Subsystem is to prepare Digital Navigation Maps that are needed for the Guidebook Compiler module in the Author subsystem to produce the Master Guidebook. The Cartographer subsystem is made of three main modules: Map Editor, Destination Editor, and Map Compiler.

Map Editor Module

The purpose of the Map Editor module is to collect, and prepare if necessary, the set of base maps that are used in the Digital Guidebook. Base maps contain all the background drawings of streets and tourist sites. Some maps are available and can be imported into the system and some may have to be drawn by the cartographer from scratch. The map editor module includes tools to do both.

Destination Editor Module

The purpose of the Destination Editor module is to place all the destinations referenced in the Digital Guidebook on the base maps and to fill their coordinates in the Destination Directory (columns X, Y, and Z as depicted in FIG. 25). The results are a complete Destination Directory and a set of Edited Maps, ready to be compiled to Navigation Maps.

The method of placing destinations on digital maps employs 3^{rd} party commercial Geographic Information Systems mapping tools. Some of the process is done on a stationary workstation and some is done with mobile devices on the grounds.

Map Compiler Module

When the cartographer is satisfied with the Edited Maps, the uses the Map Compiler module to wrap up and produce the Digital Navigation Maps in the format needed by the Author subsystem. The compilation process is completely automatic although driven by various cartographer options.

Service Subsystem

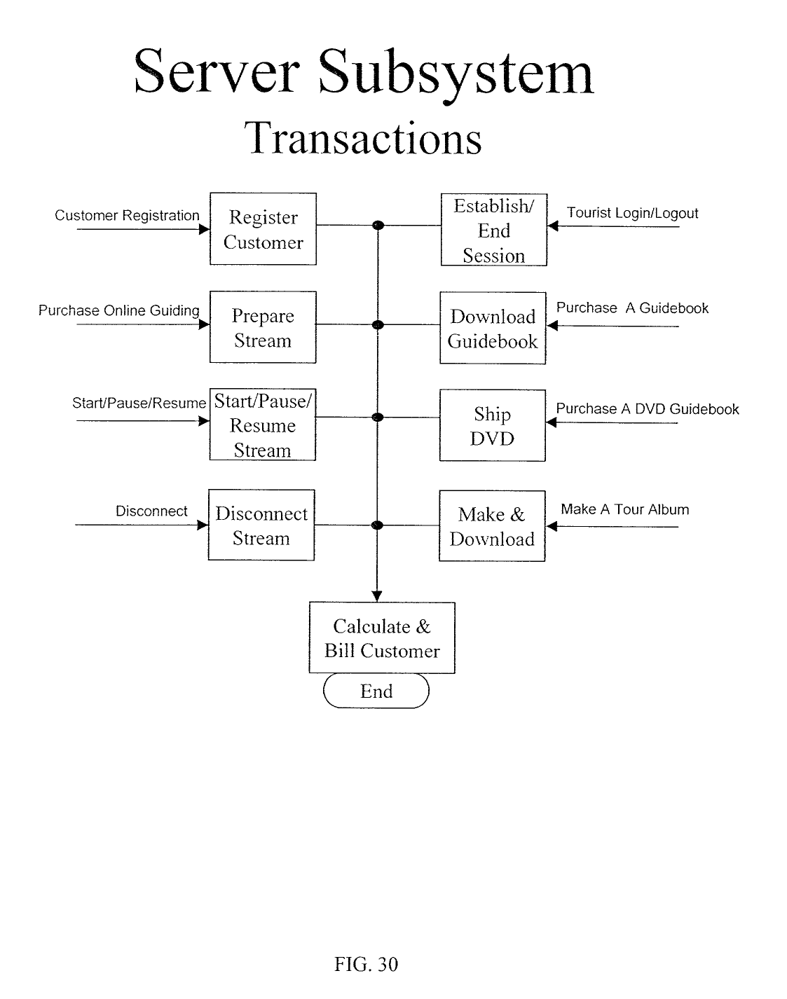

The Service Subsystem is an e-Commerce system that provides Electronic Tourist Guide products both over home Internet and cellular Internet connection. FIG. 30 depicts the main customer transactions that are unique to the invented system. The Service subsystem includes non-transaction parts such as marketing, customer relationship, information-partners relationship and other common e-Commerce components, that are not germane to the invention.

Transactions

Customer Registration

A first-time customer registers by providing personal and billing information.

Customer Login

A registered customer logs in to the Service in order to perform one or more transactions as described below. Logging in starts a customer session that ends when the customer logs out. Other guests to the Service can obtain information about the service and view the Digital Guidebook Catalogs but can't carry out transactions.

Customer Logout

The system ends the customer session and calculates the accrued charges for the session.

Purchase A Guidebook

A Digital Guidebook can be purchased for a variety of different mobile devices and downloaded either directly to the device or through the customer's home computer for fast local downloading to the device.

Purchase Online Guiding

The system prepares the online information stream for the selected Digital Guidebook.

Start/Pause/Resume Guiding

Clicking on Start button starts online guiding, alternating between navigation and narration as described in previous sections. Once started, the tourist can pause the guiding stream and resume it at any time.

Disconnect Online Guiding

Clicking on the Disconnect button stops the guiding stream to the tourist device, free the allocated system resources, and calculate the charges.

Purchase DVD Tour Reviews

A DVD Tour Review can be purchased to view whole Digital Guidebooks on home DVD platter. The DVD briefly reviews each site in the Digital Guidebook, and for any selected site the tourist can watch a multimedia review of the site.

Create A Tour Album

For online guiding, the Service can create a Tour Album at the end of the tour.

The Home subsystem can also create a Tour Album without resorting to the Service.

Extensions To The Application

Audio Guide Replacement

This extension is used to quickly replace audio guides that are popular today at tourist sites. Present audio guides are based on broadcasting prescribed sound tracks for numbered stations along the tour. With this extension, the tourist enters the same station number and receives the proper narration. The tourist arrives at the station by following leading signs as he does presently. The extension may be therefore implemented by skipping the navigation steps altogether and adding a new control “Station” that lets the tourist type in the station number, at which time the system will provide the narration.

GPS and CPS Navigation

Although the navigation method described in the document does not rely on the tourist having GPS (Global Positioning System) or CPS (Cellular Positioning System) capabilities, the fact that the system's destination directory stores the coordinates of each destination allows easy integration of these technologies into the system.

To do the integration an ‘Auto-Pilot’ navigation module is added to the system that makes use of existing GPS and CPS navigation products, and combines them with the Visual Navigation method.

Land Touring

The present application is designed to Site Touring and caters for the needs of the pedestrian tourist. After GPS or CPS navigation is combined with Visual Navigation in the Electronic Tourist Guide, the application may be further extended to include Land Tour guiding for pedestrian as well as passenger tourists. Land touring includes nature scenes and roads between tourist destinations. Beyond relying more heavily on GPS or CPS navigation (although Visual Navigation is still essential upon arrival to the destination), the extension covers larger geographical area than Site Touring and includes new types of destinations such cities and villages, nature parks, roads, treks, and view points. The basic guiding concept, though, of Visual Navigation and Multimedia Narration remains unchanged.

Enhanced Reality Guiding

Wearable Computers with practically unlimited image sizes are anticipated. With such advanced presentation capabilities, the invented application can be enhanced to provide much richer guiding experiences to the tourist:

1. Video and animation projections over the real object, for example a restored image of on archeological object projected over the real object.

2. Virtual Reality projections over reality, for example—a real walk in an old castle surrounded with Enhanced Reality sounds images of the era.

GLOSSARY

| Term | Definition |
|---|---|
| Author | A person who uses the Author Subsystem to program |
| | Digital Guidebook. |
| Cartographer | A person who uses the Cartographer Subsystem to |
| | prepare Navigation Maps, which are imbedded in the |
| | Digital Guidebooks. |
| Chapter | On the three chapter types in the Guidebook Script. |
| Guide | Contains narrations on sites, tours, tour stations, and |
| | tour objects. |
| Chapter | One of the three chapter types in the Guidebook |
| Introduction | Script. Contains general information about the |
| | guidebook itself. |
| Chapter | One of the three chapter types in the Guidebook |
| Destinations | Script. Contains tourist destinations other than tour |
| | sites. |
| Control | A user means to control the device. Device buttons |
| | and on-screen tapping are common controls. |
| Control | A user control indicating the user has arrived at the |
| On Target | destination. |
| Control | A standard control of map view. Changes the center |
| Pan | of the map. |
| Control | A user control in the Mobile Subsystem to display a |
| Show Target | picture of the current navigation target. |
| Control | A standard operation on digital maps. Changes the |
| Zoom | scale of the map. |
| Control | An implied user control activated by tapping at any |
| ‘Am I Here?’ | point on the Navigation Map. The system replies by |
| | showing a picture of a nearby recognizable object. |
| Control | A user control in the Mobile Subsystem. Allows the |
| ‘Where Am I?’ | user place a named location—street junction, place, |
| | or establishment on the map. |
| Control | A user control to swap layers in multi-layered maps. |
| Elevator | Useful for sites with multiple floors such as |
| | museums. |
| Destination | Any point to which the tourist can navigate. Each |
| | such destination has an entry in the Destination |
| | Directory. |
| Destination | A type of tourist destinations. There are a number of |
| Establishment | establishment categories: hotels, restaurant, shops, |
| | theaters, and others as defined by the author. |
| Destination | The largest scope destinations. A site could include |
| Site | the ground of a palace, for example. A site is divided |
| | to smaller destinations—tours, stations, and objects. |
| Destination | A type of tourist destination. A crossing between two |
| Street Junction | streets. |
| Destination | A type of tourist destination. A named place such as |
| Place | a town square or a monument |
| Destination | A unique internal code given to each referenced |
| Code | destination in a Digital Guidebooks. |
| Destination | A central directory of all referenced destinations in a |
| Directory | guidebook. The directory is shared between the |
| | cartographer and the author to synchronize |
| | navigation with narrations. |
| Destination | The known name of a destination. The site or the |
| Name | authorities predetermine most of the names. |
| Destination | A destination can be of several types: site, tour, tour |
| Type | station, tour object, reference object, street junction, |
| | place, and establishment. |
| Guidebook | An interim version of the Guidebook used by the |
| Edited | Author. |
| Guidebook | A module in the Author Subsystem that form the |
| Compiler | Master Guidebook from the Edited Guidebook. |
| Guidebook | A module in the Author Subsystem that allows the |
| Editor | programming of tours and integration of multimedia |
| | material and Internet Channels in the guidebook |
| | script. Creates the Edited Guidebook. |
| Guidebook | A module in the Author Subsystem that formats the |
| Producer | reduced guidebooks to the proper operating system |
| | of the mobile device. |
| Guidebook | A module in the Author Subsystem that reduces the |
| Reducer | Master Guidebook to the capabilities of specific |
| | mobile devices. |
| Guidebook | The editable format used by the Author to program |
| Script | Digital Guidebooks. A form of XML. |
| Guidebook | A final version of the Guidebook that contains |
| Master | narrations in all supported media. The Master |
| | Guidebook is reduced to multiple Digital |
| | Guidebooks for specific mobile devices. |
| Guidebook | A standard script language. The basis for the |
| XML Script | Guidebook Script language. |
| Guidebook | A version of a Master Guidebook reduced and |
| Digital | customized to match the features and the operating |
| | system of a specific mobile device. |
| Internet | A method of delivering to the tourist during the tour |
| Channels | live, timely information such as latest events, |
| | schedules and prices. |
| Map | A module in the Cartographer subsystem. Used to |
| Compiler | create Navigation Maps from the Edited Maps. |
| Map | A module in the Cartographer subsystem. Used to |
| Editor | import existing base maps and draw new ones, to |
| | create a library of Base Maps for compilation. |
| Map | A map on which the tourist navigates to his |
| Navigation | destination with the Electronic Tourist Guide. |
| Map | Coordinates of a destination. X and Y are standard |
| X, Y, and Z | longitude and latitude used in navigation systems. Z |
| Coordinates | is a relative elevation indicator in sites that have |
| | multiple elevation levels (e.g. museum floors). |
| Mobile Device | A computing and telecommunication appliance that |
| | can be used for Electronic Tourist Guiding. The |
| | invented system is presently designed for three types |
| | of mobile devices: Electronic Books, Palm |
| | Computers, and Smart Cellular Phones. Design for |
| | Wearable Computers is planned for the future. |
| Mobile Device | A collection of characteristic features of a mobile |
| Profile | device, such as computing power, memory size, and |
| | screen size. The Author subsystem automatically fits |
| | Digital Guidebooks to different device profiles. |
| Narration | Presentation of multi media content on the mobile |
| | device or the home computer. The invented system |
| | supports five media of narration: text, text with |
| | drawings, text with photo, audio, and audio-video. |
| | Narration is also provided in multiple depths and |
| | orientation according to Author-defined topics. |
| Narration | Subdivision of the narration to multiple depths and |
| Topics | orientations. A mandatory topic is GENERAL that |
| | provides minimal and general narration. |
| Narration | Files such as text files, images files, audio files, and |
| Material | audio-video files that contain narrations on tour sites |
| | and other tourist destinations. |
| Navigation | A picture of a recognizable object. Used mainly for |
| Picture | Visual Navigation but also aids in narration. |
| Visual | An invented method of navigating within a tour site. |
| Navigation | Visual Navigation complement GPS and CPS |
| | navigation where those are no available or not |
| | effective—mostly within tour sites. |
| Online Guiding | A form of renting a guidebook. Guidance is provided |
| | online through cellular Internet connection of the |
| | mobile device to the Service Subsystem. |
| Subsystem | One of the five subsystems of which the Electronic |
| Cartographer | Tourist Guide is made. Used for creating Digital |
| | Navigation Maps used by the Visual Navigation |
| | method. |
| Subsystem | One of the five subsystems of which the Electronic |
| Author | Tourist Guide is made. Used for programming |
| | multimedia Digital Guidebooks. |
| Subsystem | One of the five subsystems of which the Electronic |
| Home | Tourist Guide is made. Facilitates fast download of |
| | Digital Guidebooks to the tourist's device, to create |
| | Tour Albums, and allows large screed multimedia |
| | Armchair Touring. |
| Subsystem | One of the five subsystems of which the Electronic |
| Mobile | Tourist Guide is made. Used by the tourist for |
| | navigation and narrations on tour sites and other |
| | tourist destinations. |
| Subsystem | One of the five subsystems of which the Electronic |
| Service | Tourist Guide is made. Used to store, sell, and |
| | service Digital Guidebooks. |
| System | Reference to the Electronic Tourist Guide system. |
| Tour | A selection of objects visited in a predetermined |
| | order. A tour is divided to tour stations, places from |
| | which one or more of the objects can be conveniently |
| | observed. |
| Tour | Internet pages made of pictures of the places the |
| Album | tourist has visited, with imprinted date and time of |
| | visit. The album can be viewed, mailed to a friend, or |
| | combined the tourist's own photos. A Tour Album |
| | can be created by the Home subsystem or the Service |
| | subsystem. |
| Tour | A record of places visited and time of visit during a |
| Log | tour. At the end of the tour the Tour Log is uploaded |
| | to the Home subsystem or the Service subsystem in |
| | order to create the Tour Album. |
| Tour | A method to receive the full tour guidance without |
| Armchair | actually visiting the tour site. Armchair touring is |
| | available both on the Mobile subsystem and the |
| | Home subsystem. |
| Tour | A continuous multimedia presentation of a Digital |
| DVD Review | Guidebook on DVD. DVD Tour Reviews can be |
| | purchased from the Service subsystem. |

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A mobile computer system for electronic tourist guidance, navigation and narration, comprising:
a. A means for mobile, adaptive multimedia narrations at tour sites
b. A means for navigation at tour sites called Visual Navigation. In the absence of GPS or CPS navigation, Visual Navigation can also navigate the tourist to the tour site and to other tourist destinations.
c. A means for Internet channeling of live, timely information to enhance narration
d. A means and apparatus for Armchair Touring
e. An apparatus and means for DVD Tour Reviews
f. A means and apparatus for creation of Tour Albums

2. A workstation computer system for studio design and production of Digital Guidebooks, comprising:
a. A means and apparatus for mapping of tour sites and other tourist destinations for use by the Electronic Tourist Guide.
b. A means and apparatus for integrating map information in Digital Guidebooks
c. A means and apparatus for integrating multimedia tour material in Digital Guidebooks
d. A means and apparatus for integrating Internet channels in Digital Guidebooks
e. A means and apparatus for programming tours
f. A means and apparatus for reducing Digital Guidebooks to fit the features of different mobile devices

3. A means for selling Digital Guidebooks on ‘Pay-Per-Tour’ and ‘Pay-Per-Day’ basis.
